(19) United States
(12) Patent Application Publication
(10) Pub. No.: US 2007/0100627 A1
(43) Pub. Date: May 3, 2007

(54) Device, method, and program for selecting voice data

(75) Inventor: Yasushi Sato, Fukuoka-shi (JP)

Correspondence Address: ERIC ROBINSON, PMB 955, 21010 SOUTHBANK ST., POTOMAC FALLS, VA, 20165, US

(73) Assignee: KABUSHIKI KAISHA KENWOOD, Hachiouji-shi, Tokyo (JP)

(21) Appl. No.: 10/559,573

(22) PCT Filed: Jun. 3, 2004
(86) PCT No.: PCT/JP04/08088

§ 371 Date: Oct. 16, 2006

(30) Foreign Application Priority Data
Jun. 4, 2003 (JP) 2003-159880
Jun. 10, 2003 (JP) 2003-165582
May 25, 2004 (JP) 2004-155306

(51) Int. Cl. G10L 13/08

(52) U.S. Cl. 704/260

(57) ABSTRACT

The present invention provides a voice data selector and the like for obtaining natural synthetic speech at high speed in simple configuration. In a voice data selector of the present invention, when data expressing a message template is supplied, a voice unit editor retrieves voice unit data of a voice unit, whose reading agrees with a voice unit in the message template, from a voice unit database. On the other hand, the voice unit editor performs the cadence prediction of a message template, and specifies what agrees with each voice unit in a message template most suitably from among the retrieved voice unit data on the basis of an evaluation expression. The evaluation expression has variables of cadence prediction result, that is, the result of the primary regression of a frequency of a pitch component between voice unit data, and the time difference of utterance speed. Then, the specified voice unit data and waveform data, which an acoustic processor is made to supply instead because of unsuccessful specification, are combined with each other, and data expressing synthetic speech is generated.

### TECHNICAL FIELD

The present invention relates to a voice data selector, a voice data selection method, and a program.

### BACKGROUND ART

As a method of synthesizing voice, there exists a method called a sound recording and editing system. The sound recording and editing systems are used for audio assist systems in stations, and vehicle-mounted navigation devices and the like.

The sound recording and editing system is a method of associating a word with the voice which reads out this word with voice data, dividing a target text, which is voice-synthesized, into words, and acquiring and connecting the voice data associated with these words.

As for this sound recording and editing system, for example, Japanese Patent Application Laid-Open No. 10-49193 explains in detail (hereafter, this is called Reference 1).

Nevertheless, when voice data is simply connected, synthesized speech becomes unnatural because a frequency of a voice pitch component usually varies discontinuously on a boundary of voice data, or the like.

What is conceivable as a method of solving this problem is a method of preparing a plurality of voice data expressing the voice of reading the same phoneme by rhythms different from each other, on the other hand, predicting rhythms for a target text to be given speech synthesis, and selecting and connecting the voice data agreeing with the prediction result.

Nevertheless, in order to prepare voice data every phoneme and to obtain natural synthesized speech by the sound recording and editing system, huge memory capacity is necessary for a storage device which stores voice data, and hence, it is not suitable for an application which needs to use a small lightweight device. In addition, since the volume of target data to be searched becomes huge, it is also not suitable for an application which needs high-speed processing.

In addition, since the cadence prediction is extremely complicated processing, it is necessary to use a processor with a high throughput or the like so as to achieve this method using the cadence prediction, or to make processing executed for a long time. Hence, this method is not suitable for an application which requires high-speed processing using a simply configured device.

This invention is made in view of the above-mentioned actual conditions, and aims at providing a voice data selector, a voice data selection method, and a program for obtaining a natural synthetic speech at high speed with simple configuration.

### DISCLOSURE OF THE INVENTION

(1) In order to achieve the above-described invention objects, in a first aspect, a voice data selector of the present invention is fundamentally composed of memory means of storing a plurality of voice data expressing voice waveforms, search means of inputting text information expressing a text and retrieving voice data expressing a waveform of a voice unit whose reading is common to that of a voice unit which constitutes the above-mentioned text from among the above-mentioned voice data, and selection means of selecting each one of voice data corresponding to each voice unit which constitutes the above-mentioned text from among the searched voice data so that a value obtained by totaling the difference of pitches in boundaries of adjacent voice units in the above-mentioned whole text may become minimum.

The above-mentioned voice data selector may be equipped with further speech synthesis means of generating data expressing synthetic speech by combining selected voice data mutually.

In addition, a voice data selection method of the present invention fundamentally includes a series of processing steps of storing a plurality of voice data expressing voice waveforms, inputting text information expressing a text, retrieving voice data expressing a waveform of a voice unit whose reading is common to that of a voice unit which constitutes the above-mentioned text from among the above-mentioned voice data, and selecting each one of voice data corresponding to each voice unit which constitutes the above-mentioned text from among the searched voice data so that a value obtained by totaling the difference of pitches in boundaries of adjacent voice units in the above-mentioned whole text may become minimum.

Furthermore, a computer program of this invention makes a computer function as memory means of storing a plurality of voice data expressing voice waveforms, search means of inputting text information expressing a text and retrieving voice data expressing a waveform of a voice unit whose reading is common to that of a voice unit which constitutes the above-mentioned text from among the above-mentioned voice data, and selection means of selecting each one of voice data corresponding to each voice unit which constitutes the above-mentioned text from among the searched voice data so that a value obtained by totaling the difference of pitches in boundaries of adjacent voice units in the above-mentioned whole text may become minimum.

(2) In a second aspect of the present invention, a voice selector is fundamentally composed of memory means of storing a plurality of voice data expressing voice waveforms, prediction means of predicting the time series change of pitch of a voice unit by inputting text information expressing a text and performing cadence prediction for the voice unit which constitutes the text concerned, selection means of select from among the above-mentioned voice data the voice data which expresses a waveform of a voice unit whose reading is common to that of a voice unit which constitutes the above-mentioned text, and whose time series change of pitch has the highest correlation with the prediction result by the above-mentioned prediction means.

The above-mentioned selection means may specify the strength of correlation between the time series change of pitch of the voice data concerned, and the result of the prediction by the above-mentioned prediction means on the basis of the result of regression calculation which performs primary regression between the time series change of pitch of a voice unit which voice data expresses, and the time series change of pitch of a voice unit in the above-mentioned text whose reading is common to the voice unit concerned.

The above-mentioned selection means may specify the strength of correlation between the time series change of pitch of the voice data concerned, and the result of prediction by the above-mentioned prediction means on the basis of a correlation coefficient between the time series change of pitch of a voice unit which voice data expresses, and the time series change of pitch of a voice unit in the above-mentioned text whose reading is common to the voice unit concerned.

In addition, another voice selector of this invention is composed of memory means of storing a plurality of voice data expressing voice waveforms, prediction means of predicting the time length of the voice unit concerned and the time series change of pitch of a voice unit by inputting text information expressing a text and performing cadence prediction for the voice unit in the text concerned, and selection means of specifying an evaluation value of each voice data expressing a waveform of a voice unit whose reading is common to a voice unit in the above-mentioned text and selecting voice data whose evaluation value expresses the highest evaluation, wherein the above-mentioned evaluation value is obtained from a function of a numerical value which expresses correlation between the time series change of pitch of a voice unit which voice data expresses, and the prediction result of the time series change of pitch of a voice unit in the above-mentioned text whose reading is common to the voice unit concerned, and a function of difference between the prediction result of the time length of the voice unit which the voice data concerned expresses, and the time length of the voice unit in the above-mentioned text whose reading is common to the voice unit concerned.

The above-mentioned numerical value expressing the correlation may be composed of a gradient of a primary function obtained by primary regression between the time series change of pitch of a voice unit which voice data expresses, and the time series change of pitch of a voice unit in the above-mentioned text whose reading is common to that of the voice unit concerned.

In addition, the above-mentioned numerical value expressing the correlation may be composed of an intercept of a primary function obtained by the primary regression between the time series change of pitch of a voice unit which voice data expresses, and the time series change of pitch of a voice unit in the above-mentioned text whose reading is common to that of the voice unit concerned.

The above-mentioned numerical value expressing the correlation may be composed of a correlation coefficient between the time series change of pitch of a voice unit which voice data expresses, and the prediction result of the time series change of pitch of a voice unit in the above-mentioned text whose reading is common to that of the voice unit concerned.

The above-mentioned numerical value expressing the correlation may be composed of the maximum value of correlation coefficients between a function which what is given various bit count cyclic shifts to the data expressing the time series change of pitch of a voice unit which voice data expresses, and a function expressing the prediction result of the time series change of pitch of a voice unit in the above-mentioned text whose reading is common to that of the voice unit concerned.

The above-mentioned memory means may associate and store phonetic data expressing the reading of voice data with the voice data concerned, and in addition, the above-mentioned selection means may treat voice data, with which the phonetic data expressing the reading agreeing with the reading of a voice unit in the text is associated, as voice data expressing a waveform of a voice unit whose reading is common to the voice unit concerned.

The above-mentioned voice selector may be equipped with further speech synthesis means of generating data expressing synthetic speech by combining selected voice data mutually.

The above-mentioned voice selector may be equipped with lacked portion synthesis means of synthesizing voice data expressing a waveform of a voice unit in regard to the voice unit, on which the above-mentioned selection means was not able to select voice data, among voice units in the above-mentioned text without using voice data which the above-mentioned memory means stores. In addition, the above-mentioned speech synthesis means may generate data expressing synthetic speech by combining the voice data, which the above-mentioned selection means selected, with voice data which the above-mentioned lacked portion synthesis means synthesized.

In addition, a voice selection method of this invention includes a series of processing steps of storing a plurality of voice data expressing voice waveforms, predicting the time series change of pitch of a voice unit by inputting text information expressing a text and performing cadence prediction for the voice unit which constitutes the text concerned, and selecting from among the above-mentioned voice data the voice data which expresses a waveform of a voice unit whose reading is common to that of a voice unit which constitutes the above-mentioned text, and whose time series change of pitch has the highest correlation with the prediction result by the above-mentioned prediction means.

Furthermore, another voice selection method of this invention includes a series of processing steps of storing a plurality of voice data expressing voice waveforms, predicting the time length of a voice unit and the time series change of pitch of the voice unit concerned by inputting text information expressing a text and performing cadence prediction for the voice unit in the text concerned, specifying an evaluation value of each voice data expressing a waveform of a voice unit whose reading is common to a voice unit in the above-mentioned text and selecting voice data whose evaluation value expresses the highest evaluation, wherein the above-mentioned evaluation value is obtained from a function of a numerical value which expresses correlation between the time series change of pitch of a voice unit which voice data expresses, and the prediction result of the time series change of pitch of a voice unit in the above-mentioned text whose reading is common to the voice unit concerned, and a function of difference between the prediction result of the time length of the voice unit which the voice data concerned expresses, and the time length of the voice unit in the above-mentioned text whose reading is common to the voice unit concerned.

In addition, a computer program of this invention makes a computer function as memory means of storing a plurality of voice data expressing voice waveforms, prediction means of predicting the time series change of pitch of a voice unit by inputting text information expressing a text and performing cadence prediction for the voice unit which constitutes the text concerned, and selection means of select from among the above-mentioned voice data the voice data which expresses a waveform of a voice unit whose reading is common to that of a voice unit which constitutes the above-mentioned text, and whose time series change of pitch has the highest correlation with the prediction result by the above-mentioned prediction means.

Furthermore, another computer program of this invention is a program for causing a computer to function as memory means of storing a plurality of voice data expressing voice waveforms, prediction means of predicting the time length of a voice unit and the time series change of pitch of the voice unit concerned by inputting text information expressing a text and performing cadence prediction for the voice unit in the text concerned, and selection means of specifying an evaluation value of each voice data expressing a waveform of a voice unit whose reading is common to a voice unit in the above-mentioned text and selecting voice data whose evaluation value expresses the highest evaluation, wherein the above-mentioned evaluation value is obtained from a function of a numerical value which expresses the correlation between the time series change of pitch of a voice unit which voice data expresses, and the prediction result of the time series change of pitch of a voice unit in the above-mentioned text whose reading is common to the voice unit concerned, and a function of difference between the prediction result of the time length of the voice unit which the voice data concerned expresses, and the time length of the voice unit in the above-mentioned text whose reading is common to the voice unit concerned.

(3) In a third aspect of the present invention, a voice data selector is fundamentally composed of memory means of storing a plurality of voice data expressing voice waveforms, text information input means of inputting text information expressing a text, a search section of retrieving the voice data which has a portion whose reading is common to that of a voice unit in a text which the above-mentioned text information expresses, and selection means of obtaining an evaluation value according to a predetermined evaluation criterion on the basis of the relationship between mutually adjacent voice data when each of the above-mentioned searched voice data is connected according to the text which text information expresses, and selecting the combination of the voice data, which will be outputted, on the basis of the evaluation value concerned.

The above-mentioned evaluation criterion is a reference which determines an evaluation value which expresses correlation between the voice, which voice data expresses, and the cadence prediction result, and the relationship between mutually adjacent voice data. The above-mentioned evaluation value is obtained on the basis of an evaluation expression which contains at least any one of a parameter which shows a feature of voice which the above-mentioned voice data expresses, a parameter which shows a feature of voice obtained by mutually combining the voice which the above-mentioned voice data expresses, and a parameter which shows a feature relating to speech time length.

The above-mentioned evaluation criterion is a reference which determines an evaluation value which expresses correlation between the voice, which voice data expresses, and the cadence prediction result, and the relationship between mutually adjacent voice data. The above-mentioned evaluation value may includes a parameter which shows a feature of voice obtained by mutually combining the voice which the above-mentioned voice data expresses, and may be obtained on the basis of an evaluation expression which contains at least any one of a parameter which shows a feature of voice which the above-mentioned voice data expresses, and a parameter which shows a feature relating to speech time length.

The parameter which shows a feature of voice obtained by mutually combining the voice which the above-mentioned voice data expresses may be obtained on the basis of difference between pitches in the boundary of mutually adjacent voice data in the case of selecting at a time one voice data corresponding to each voice unit which constitutes the above-mentioned text from among the voice data which expressing waveforms of voice having a portion whose reading is common to that of a voice unit in a text which the above-mentioned text information expresses.

The above-mentioned voice unit data selector may be equipped with prediction means of predicting the time length of the voice unit concerned and the time series change of pitch of the voice unit concerned by inputting text information expressing a text and performing cadence prediction for the voice unit in the text concerned. The above-mentioned evaluation criteria are a reference which determines an evaluation value which expresses the correlation or difference between the voice, which voice data expresses, and the cadence prediction result of the above-mentioned cadence prediction means. The above-mentioned evaluation value may be obtained on the basis of a function of a numerical value which expresses the correlation between the time series change of pitch of a voice unit which voice data expresses, and the prediction result of the time series change of pitch of a voice unit in the above-mentioned text whose reading is common to the voice unit concerned, and/or a function of difference between the time length of the voice unit which the voice data concerned expresses, and the prediction result of the time length of the voice unit in the above-mentioned text whose reading is common to the voice unit concerned.

The above-mentioned numerical value expressing the above-mentioned correlation may be composed of a gradient and/or an intercept of a primary function obtained by the primary regression between the time series change of pitch of a voice unit which voice data expresses, and the time series change of pitch of a voice unit in the above-mentioned text whose reading is common to that of the voice unit concerned.

The above-mentioned numerical value expressing the correlation may be composed of a correlation coefficient between the time series change of pitch of a voice unit which voice data expresses, and the prediction result of the time series change of pitch of a voice unit in the above-mentioned text whose reading is common to that of the voice unit concerned.

Alternatively, the above-mentioned numerical value expressing the above-mentioned correlation may be composed of the maximum value of correlation coefficients between a function which what is given various bit count cyclic shifts to the data expressing the time series change of pitch of a voice unit which voice data expresses, and a function expressing the prediction result of the time series change of pitch of a voice unit in the above-mentioned text whose reading is common to that of the voice unit concerned.

The above-mentioned memory means may store phonetic data expressing the reading of voice data with associating it with the voice data concerned, and the above-mentioned selection means may treat voice data, with which phonetic data expressing the reading agreeing with the reading of a voice unit in the above-mentioned text is associated, as voice data expressing a waveform of a voice unit whose reading is common to the voice unit concerned.

The above-mentioned voice unit data selector may be further equipped with speech synthesis means of generating data expressing synthetic speech by combining selected voice data mutually.

The above-mentioned voice unit data selector may be equipped with lacked portion synthesis means of synthesizing voice data expressing a waveform of a voice unit in regard to a voice unit, on which the above-mentioned selection means was not able to select voice data, among voice units in the above-mentioned text without using voice data which the above-mentioned memory means stores. In addition, the above-mentioned speech synthesis means may generate data expressing synthetic speech by combining the voice data, which the above-mentioned selection means selected, with voice data which the above-mentioned lacked portion synthesis means synthesized.

In addition, a voice data selection method of this invention includes a series of processing steps of storing a plurality of voice data expressing voice waveforms, inputting text information expressing a text, retrieving the voice data which has a portion whose reading is common to that of a voice unit in a text which the above-mentioned text information expresses, and obtaining an evaluation value according to predetermined evaluation criteria on the basis of relationship between mutually adjacent voice data when each of the above-mentioned searched voice data is connected according to the text which text information expresses, and selecting the combination of the voice data, which will be outputted, on the basis of the evaluation value concerned.

Furthermore, a computer program of this invention is a program for causing a computer to function as memory means of storing a plurality of voice data expressing voice waveforms, text information input means of inputting text information expressing a text, a search section of retrieving the voice data which has a portion whose reading is common to that of a voice unit in a text which the above-mentioned text information expresses, and selection means of obtaining an evaluation value according to a predetermined evaluation criterion on the basis of the relationship between mutually adjacent voice data when each of the above-mentioned retrieved voice data is connected according to the text which text information expresses, and selecting the combination of the voice data, which will be outputted, on the basis of the evaluation value concerned.

### BRIEF DESCRIPTION OF THE DRAWINGS

FIG. 1 is a block diagram showing the structure of a speech synthesis system which relates to each embodiment of this invention;

FIG. 2 is a schematic diagram showing the data structure of a voice unit database in a first embodiment of this invention;

FIG. 3(a) is a graph for explaining the processing of primary regression between the prediction result of a frequency of a pitch component for a voice unit, and the time series change of a frequency of a pitch component of a voice unit data expressing a waveform of a voice unit whose reading correspond to this voice unit, FIG. 3(b) is a graph showing an example of values of prediction result data and pitch component data which are used in order to obtain a correlation coefficient;

FIG. 4 is a schematic diagram showing the data structure of a voice unit database in a second embodiment of this invention;

FIG. 5(a) is a drawing showing the reading of a message template, FIG. 5(b) is a list of voice unit data supplied to a voice unit editor, and FIG. 5(c) is a drawing showing absolute values of difference between a frequency of a pitch component at a tail of a preceding voice unit, and a frequency of a pitch component at a head of a consecutive voice unit, and FIG. 5(d) is a drawing showing which voice unit data a voice unit editor selects;

FIG. 6 is a flowchart showing the processing in the case that a personal computer which functions as a speech synthesis system according to each embodiment of this invention acquires free text data;

FIG. 7 is a flowchart showing the processing in the case that a personal computer which functions as a speech synthesis system according to each embodiment of this invention acquires delivery character string data;

FIG. 8 is a flowchart showing the processing in the case that a personal computer which functions as a speech synthesis system according to a first embodiment of this invention acquires template message data and utterance speed data;

FIG. 9 is a flowchart showing the processing in the case that a personal computer which functions as a speech synthesis system according to a second embodiment of this invention acquires template message data and utterance speed data; and

FIG. 10 is a flowchart showing the processing in the case that a personal computer which functions as a speech synthesis system according to a third embodiment of this invention acquires template message data and utterance speed data;

### BEST MODE FOR CARRYING OUT THE INVENTION

Hereafter, embodiments of this invention will be explained with reference to drawings with exemplifying speech synthesis systems.

### First Embodiment

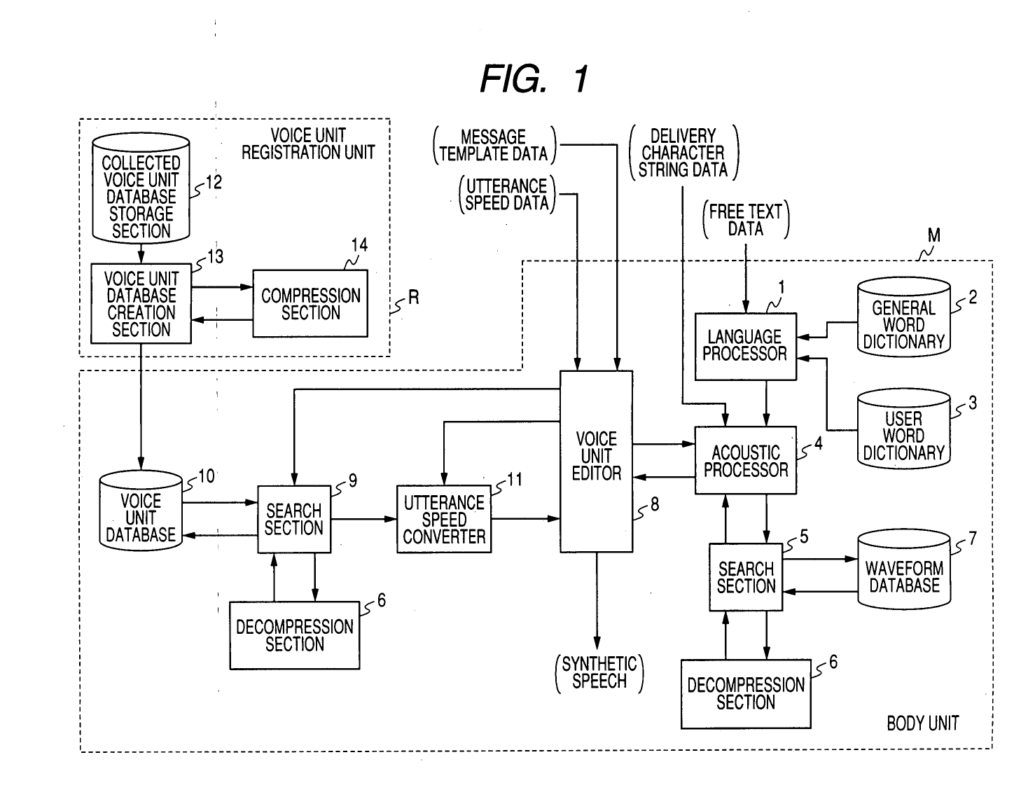

FIG. 1 is a diagram showing the structure of a speech synthesis system according to a first embodiment of this invention. As shown, this speech synthesis system is composed of a body unit M and a voice unit registration unit R.

The body unit M is composed of a language processor 1, a general word dictionary 2, a user word dictionary 3, an acoustic processor 4, a search section 5, a decompression section 6, a waveform database 7, a voice unit editor 8, a search section 9, a voice unit database 10, and a utterance speed converter 11.

Each of the language processor 1, acoustic processor 4, search section 5, decompression section 6, voice unit editor 8, search section 9, and utterance speed converter 11 is composed of a processor such as a CPU (Central Processing Unit) or a DSP (Digital Signal Processor), and memory which stores a program for this processor to execute, and performs the processing described later.

In addition, a single processor may be made to perform a part or all of the functions of the language processor 1, acoustic processor 4, search section 5, decompression section 6, voice unit editor 8, search section 9, and utterance speed converter 11.

The general word dictionary 2 is composed of nonvolatile memory such as PROM (Programmable Read Only Memory) or a hard disk drive. A manufacturer of this speech synthesis system, or the like makes beforehand words, including ideographic characters (i.e., kanji, or the like) and phonograms (i.e., kana, phonetic symbols, or the like) expressing reading such as this word, stored in the general word dictionary 2 with associating each other.

The user word dictionary 3 is composed of nonvolatile memory, which is data rewritable, such as EEPROM (Electrically Erasable/Programmable Read Only Memory) and a hard disk drive, and a control circuit which controls the writing of data into this nonvolatile memory. In addition, a processor may function as this control circuit and a processor which performs some or all of functions of the language processor 1, acoustic processor 4, search section 5, decompression section 6, voice unit editor 8, search section 9, and utterance speed converter 11 may be made to function as the control circuit of the user word dictionary 3.

The user word dictionary 3 acquires a word and the like including ideographic characters, and phonograms expressing the reading of this word and the like from the outside according to the operation of a user, and stores them with associating them with each other. What is necessary in the user word dictionary 3 is just that words which are not stored in the general word dictionary 2, and phonograms expressing their reading are stored.

The waveform database 7 is composed of nonvolatile memory such as PROM or a hard disk drive. The manufacturer of this speech synthesis system or the like made phonograms and compressed waveform data, which is obtained by performing the entropy coding of waveform data expressing waveforms of unit voice which these phonograms express expresses, stored beforehand in the waveform database 7 with being associated with each other. The unit voice is short voice in extent which is used in a method of a speech synthesis system by rule, and specifically, is voice divided in units such as a phoneme and a VCV (Vowel-Consonant-vowel) syllable. In addition, what is sufficient as waveform data before entropy coding is, for example, to be composed of data in a digital format which is given PCM (Pulse Code Modulation).

The voice unit database 10 is composed of nonvolatile memory such as PROM or a hard disk drive.

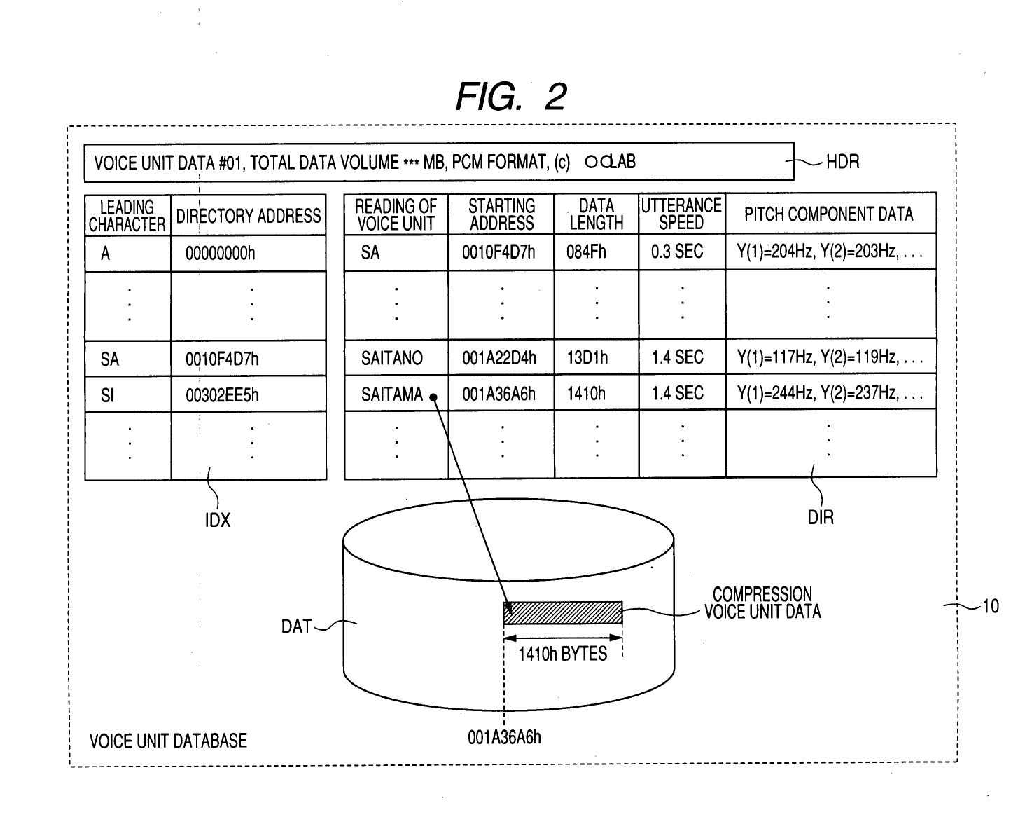

For example, the data which have the data structure shown in FIG. 2 is stored in the voice unit database 10. Thus, the data stored in the voice unit database 10 is divided into four kinds: a header section HDR; an index section IDX; a directory section DIR; and a data section DAT, as shown.

In addition, the storage of data into the voice unit database 10 is performed, for example, beforehand by the manufacturer of this speech synthesis system and/or by the voice unit registration unit R performing the operation described later.

Data for identifying the voice unit database 10, and data showing the data volume and data formats and the like of the index section IDX, directory section DIR, and data section DAT, and the possession of copyrights are loaded in the header section HDR.

The compression voice unit data obtained by performing the entropy coding of voice unit data expressing a waveform of a voice unit is loaded in the data section DAT.

In addition, the voice unit means one continuous zone which contains one or more phonemes among voice, and it is usually composed of a section for one or more words.

Furthermore, what is sufficient as voice unit data before entropy coding is to be composed of data (for example, data in a digital format which is given PCM) in the same format as waveform data before entropy coding for the creation of the above-described compressed waveform data.

In the directory section DIR, in regard to individual compression audio data,

(A) data (voice unit reading data) expressing phonograms which expresses the reading of a voice unit which this compression voice unit data expresses,

(B) data expressing an address of a head of a storage location where this compression voice unit data is stored,

(C) data expressing the data length of this compression voice unit data,

(D) data (speed initial value data) expressing the utterance speed (time length at the time of regenerating) of a voice unit which this compression voice unit data expresses,

(E) data (pitch component data) expressing the time series change of a frequency of a pitch component of this voice unit,

are stored in a form of being associated with each other. (In addition, it is assumed that an address is applied to a storage area of the voice unit database 10.)

In addition, FIG. 2 exemplifies the case that compression voice unit data with the data volume of 1410h bytes which expresses a waveform of a voice unit whose reading is “SAITAMA” as data contained in the data section DAT is stored in a logical position whose head address is 001A36A6h. (In addition in this specification and drawings, a number to whose tail “h” is affixed expresses a hexadecimal.)

Furthermore, it is assumed that pitch component data is, for example, data expressing a sample Y(i) (let a total number of samples be n, and i is a positive integer not larger than n) obtained by sampling a frequency of a pitch component of a voice unit as shown.

Moreover, at least data (A) (that is, voice unit reading data) among the above-described set of data (A) to (E) is stored in a storage area of the voice unit database 10 in the state of being sorted according to the order determined on the basis of phonograms which voice unit reading data express (i.e., in the state of being located in the address descending order according to the order of Japanese syllabary when the phonograms are kana).

Data for specifying an approximate logical position of data in the directory section DIR on the basis of voice unit reading data is stored in the index section IDX. Specifically, for example, assuming voice unit reading data expresses kana, a kana character and the data showing that voice unit reading data whose leading character is this kana character exist in what range of addresses are stored with being associated with each other.

In addition, single nonvolatile memory may be made to perform a part or all of functions of the general word dictionary 2, user word dictionary 3, waveform database 7, and voice unit database 10.

Data into the voice unit database 10 is stored by the voice unit registration unit R shown in FIG. 1. The voice unit registration unit R is composed of a collected voice unit database storage section 12, a voice unit database creation section 13, and a compression section 14 as shown. In addition, the voice unit registration unit R may be connected detachably with the voice unit database 10, and, in this case, a body unit M may be made to perform the below-mentioned operation in the state that the voice unit registration unit R is separated from the body unit M, except newly writing data in the voice unit database 10.

The collected voice unit database storage section 12 is composed of nonvolatile memory, which can rewrite data, such as a hard disk drive, or the like.

In the collected voice unit database storage section 12, a phonograms expressing the reading of a voice unit, and voice unit data expressing a waveform obtained by collecting what people actually uttered this voice unit are stored beforehand with being associated with each other by the manufacturer of this speech synthesis system, or the like. In addition, this voice unit data may be just composed of, for example, data in a digital format which is given PCM.

The voice unit database creation section 13 and compression section 14 are composed of processors such as a CPU, and memory which stores a program which this processor executes, and perform the processing, later described, according to this program.

In addition, a single processor may be made to perform a part or all of functions of the voice unit database creation section 13 and compression section 14, and the processor performing the part or all of functions of the language processor 1, acoustic processor 4, search section 5, decompression section 6, voice unit editor 8, search section 9, and utterance speed converter 11 may further perform functions of the voice unit database creation section 13 and compression section 14. In addition, the processor performing the functions of the voice unit database creation section 13 and compression section 14 may further perform the functions of a control circuit of the collected voice unit database storage section 12.

The voice unit database creation section 13 reads a phonogram and voice unit data, which are associated with each other, from the collected voice unit database storage section 12, and specifies the time series change of a frequency of a pitch component of voice which this voice unit data expresses, and utterance speed.

What is necessary for the specification of utterance speed is, for example, just to perform specification by counting the number of samples of this voice unit data.

On the other hand, the time series change of a frequency of a pitch component can be specified, for example, just by performing a cepstrum analysis to this voice unit data. Specifically, for example, a waveform which voice unit data expresses is divided into many small parts on time base, the strength of each of the small parts obtained is converted into a value substantially equal to a logarithm (a base of the logarithm is arbitrary) of an original value, and the spectrum (that is, cepstrum) of this small part whose value is converted is obtained by a method of a fast Fourier transform (or another arbitrary method of generating the data which expresses the result of a Fourier transform of a discrete variable). Then, a minimum value among frequencies which give maximal values of this cepstrum is specified as a frequency of the pitch component in this small part.

In addition, for example, after converting voice unit data into pitch waveform data by the method disclosed in Japanese Patent Application Laid-Open No. 2003-108172, the time series change of a frequency of a pitch component is specified on the basis of this pitch waveform data, then, favorable result is expectable. Specifically, voice unit data may be converted into a pitch waveform signal by filtering voice unit data to extract a pitch signal, dividing a waveform, which voice unit data expresses, into zones of unit pitch length on the basis of the extracted pitch signal, specifying a phase shift on the basis of the correlation between with the pitch signal for each zone, and arranging a phase of each zone. Then, the time series change of a frequency of a pitch component may be specified by treating the obtained pitch waveform signal as voice unit data, and performing the cepstrum analysis.

On the other hand, the voice unit database creation section 13 supplies the voice unit data read from the collected voice unit database storage section 12 to the compression section 14.

The compression section 14 performs the entropy coding of voice unit data supplied from the voice unit database creation section 13 to produce compressed voice unit data, and returns them to the voice unit database creation section 13.

When the time series change of utterance speed and a frequency of a pitch component of voice unit data is specified, and this voice unit data is given the entropy coding to become compressed voice unit data and is returned from the compression section 14, the voice unit database creation section 13 writes this compressed voice unit data into a storage area of the voice unit database 10 as data which constitutes the data section DAT.

In addition, the voice unit database creation section 13 writes a phonogram read from the collected voice unit database storage section 12 as what expresses the reading of the voice unit, which the written compressed voice unit data read expresses, in a storage area of the voice unit database 10 as voice unit reading data.

Moreover, a leading address of the written-in compressed voice unit data in the storage area of the voice unit database 10 is specified, and this address is written in the storage area of the voice unit database 10 as the above-mentioned data (B).

In addition, the data length of this compressed voice unit data is specified, and the specified data length is written in the storage area of the voice unit database 10 as the data (C).

In addition, the data which expresses the result of specification of the time series change of utterance speed of a voice unit and a frequency of a pitch component which this compressed voice unit data expresses is generated, and is written in the storage area of the voice unit database 10 as speed initial value data and pitch component data.

Next, the operation of this speech synthesis system will be explained.

First, explanation will be performed assuming the language processor 1 acquired from the outside free text data which describes a text (free text) being prepared by a user as an object for making this speech synthesis system synthesize voice, and including ideographic characters.

In addition, a method of the language processor 1 acquiring free text data is arbitrary, for example, it may be acquired from an external device or a network through an interface circuit not shown, or it may be read from a recording media (i.e., a floppy (registered trademark) disk, CD-ROM, or the like) set in a recording medium drive device, not shown, through this recording medium drive device. In addition, the processor performing the functions of the language processor 1 may deliver text data, used in other processing executed by itself, to the processing of the language processor 1 as free text data.

When acquiring the free text data, the language processor 1 specifies ideographic characters, which expresses its reading, by searching the general word dictionary 2 and user word dictionary 3 for each of phonograms included in this free text. Then, this ideographic character is substituted to the phonogram to be specified. Then, the language processor 1 supplies a phonogram string, obtained as the result of substituting all the ideographic characters in the free text to the phonograms, to the acoustic processor 4.

When the phonogram string is supplied from the language processor 1, the acoustic processor 4 instructs the search section 5 to search a waveform of unit voice, which the phonogram concerned expresses, for each of phonograms included in this phonogram string.

The search section 5 responds to this instruction to search the waveform database 7, and retrieves the compressed waveform data which expresses a waveform of the unit voice which each of the phonograms included in the phonogram string expresses. Then, the retrieved compressed waveform data is supplied to the decompression section 6.

The decompression section 6 restores the compressed waveform data supplied from the search section 5 into the waveform data before being compressed, and returns it to the search section 5. The search section 5 supplies the waveform data returned from the decompression section 6 to the acoustic processor 4 as the search result.

The acoustic processor 4 supplies the waveform data, supplied from the search section 5, to the voice unit editor 8 in the order according to the alignment of each phonogram within the phonogram string supplied from the language processor 1.

When receiving the waveform data from the acoustic processor 4, the voice unit editor 8 combines this waveform data with each other in the supplied order to output them as data (synthetic speech data) expressing synthetic speech. This synthetic speech synthesized on the basis of free text data is equivalent to voice synthesized by the method of a speech synthesis system by rule.

In addition, since the method by which the voice unit editor 8 outputs synthetic speech data is arbitrary, the synthetic speech which this synthetic speech data expresses may be regenerated, for example, through a D/A (Digital-to-Analog) converter or a loudspeaker which is not shown. In addition, it may be sent out to an external device or an external network through an interface circuit which is not shown, or may be also written in a recording medium set in a recording medium drive device, which is not shown, through this recording medium drive device. In addition, the processor which performs the functions of the voice unit editor 8 may also deliver synthetic speech data to other processing executed by itself.

Next, it is assumed that the acoustic processor 4 acquires data (delivery character string data) which is distributed from the outside and which expresses a phonogram string. (In addition, since the method by which the acoustic processor 4 acquires delivery character string data is also arbitrary, for example, the delivery character string data may be acquired by a method similar to the method by which the language processor 1 acquires free text data.)

In this case, the acoustic processor 4 treats the phonogram string, which delivery character string data expresses, similarly to a phonogram string which is supplied from the language processor 1. As a result, the compressed waveform data corresponding to the phonogram which is included in the phonogram string which delivery character string data expresses is retrieved by the search section 5, and waveform data before being compressed is restored by the decompression section 6. Each restored waveform data is supplied to the voice unit editor 8 through the acoustic processor 4, and the voice unit editor 8 combines these waveform data with each other in the order according to the alignment of each phonogram in the phonogram string which delivery character string data expresses to output them as synthetic speech data. This synthetic speech data synthesized on the basis of delivery character string data expresses voice synthesized by the method of a speech synthesis system by rule.

Next, it is assumed that the voice unit editor 8 acquires message template data and utterance speed data.

In addition, message template data is data of expressing a message template as a phonogram string, and utterance speed data is data of expressing a designated value (a designated value of time length when this message template is uttered) of the utterance speed of the message template which message template data expresses.

Furthermore, since the method by which the voice unit editor 8 acquires message template data and utterance speed data is arbitrary, message template data and utterance speed data may be acquired, for example, by a method similar to the method by which the language processor 1 acquires free text data.

When message template data and utterance speed data are supplied to the voice unit editor 8, the voice unit editor 8 instructs the search section 9 to retrieve all the compressed voice unit data with which phonograms agreeing with phonograms which express the reading of a voice unit included in a message template are associated.

The search section 9 responds to the instruction of the voice unit editor 8 to search the voice unit database 10, retrieves applicable compressed voice unit data, and the above-described voice unit reading data, speed initial value data, and pitch component data which are associated with the applicable compressed voice unit data, and supplies the retrieved compressed waveform data to the decompression section 6. Also when a plurality of compressed voice unit data is applicable to one voice unit, all the applicable compressed voice unit data are retrieved as candidates of data used for speech synthesis. On the other hand, when there exists a voice unit for which compressed voice unit data cannot be retrieved, the search section 9 generates the data (hereafter, this is called lacked portion identification data) which identifies the applicable voice unit.

The decompression section 6 restores the compressed voice unit data supplied from the search section 9 into the voice unit data before being compressed, and returns it to the search section 9. The search section 9 supplies the voice unit data returned from the decompression section 6, and the voice unit reading data, speed initial value data and pitch component data, which are retrieved, to the utterance speed converter 11 as search result. In addition, when lacked portion identification data is generated, this lacked portion identification data is also supplied to the utterance speed converter 11.

On the other hand, the voice unit editor 8 instructs the utterance speed converter 11 to convert the voice unit data supplied to the utterance speed converter 11 to make the time length of the voice unit, which the voice unit data concerned expresses, coincide with the speed which utterance speed data shows.

The utterance speed converter 11 responds to the instruction of the voice unit editor 8, converts the voice unit data, supplied from the search section 9, so as to correspond to the instruction, and supplies it to the voice unit editor 8. Specifically, for example, after specifying the original time length of the voice unit data supplied from the search section 9 on the basis of the retrieved speed initial value data, this voice unit data is resampled, and the number of samples of this voice unit data may be made to be time length corresponding to the speed which the voice unit editor 8 instructed.

In addition, the utterance speed converter 11 also supplies the voice unit reading data, speed initial value data, and pitch component data, which are supplied from the search section 9, to the voice unit editor 8, and when lacked portion identification data are supplied from the search section 9, this lacked portion identification data is also further supplied to the voice unit editor 8.

Furthermore, when utterance speed data is not supplied to the voice unit editor 8, the voice unit editor 8 may instruct the utterance speed converter 11 to supply the voice unit data, supplied to the utterance speed converter 11, to the voice unit editor 8 without conversion, and the utterance speed converter 11 may respond to this instruction and may supply the voice unit data, supplied from the search section 9, to the voice unit editor 8 as it is.

When receiving the voice unit data, voice unit reading data, speed initial value data, and pitch component data from the utterance speed converter 11, the voice unit editor 8 selects one piece of voice unit data expressing a waveform, which can be most approximate to a waveform of the voice unit which constitutes a message template, every voice unit from among the supplied voice unit data.

Specifically, first, by analyzing a message template, which message template data expresses, for example, on the basis of a method of cadence prediction such as the “Fujisaki model”, “TOBI (Tone and Break Indices)”, or the like, the voice unit editor 8 predicts the time series change of a frequency of a pitch component of each voice unit in this message template. Then, the data (hereafter, this is called prediction result data) in a digital format which expresses what the prediction result of the time series change of a frequency of a pitch component is sampled is generated every voice unit.

Next, the voice unit editor 8 obtains the correlation between prediction result data which expresses the prediction result of the time series change of a frequency of a pitch component of this voice unit, and pitch component data which expresses the time series change of a frequency of a pitch component of voice unit data which expresses a waveform of a voice unit whose reading agrees with this voice unit, for each voice unit in a message template.

Further specifically, the voice unit editor 8 calculates, for example, a value α shown in the right-hand side of Formula 1 and a value β shown in the right-hand side of Formula 2, for each pitch component data supplied from the utterance speed converter 11.

$$α = \frac{{\sum }_{i = 1}^{n} [ \{ X ( i ) - mx \} \cdot \{ Y ( i ) - my \} ]}{{\sum }_{i = 1}^{n} {\{ X ( i ) - mx \}}^{2}}$$

$$where mx = {\sum }_{i = 1}^{n} \frac{X ( i )}{n} , my = {\sum }_{i = 1}^{n} \frac{Y ( i )}{n}$$

$$β = my - ( α \cdot mx )$$

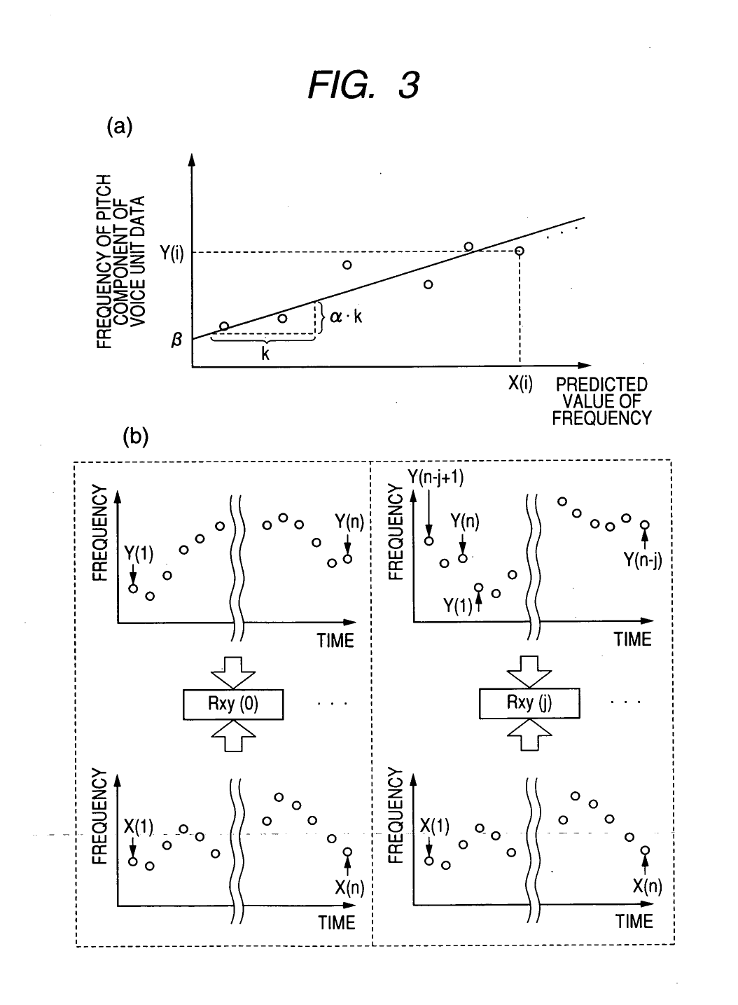

As shown in FIG. 3(a), when primary regression of a value of an i-th sample Y(i) of pitch component data (the total number of samples is made to be n pieces) for voice unit data which expresses a waveform of a voice unit whose reading agrees with this voice unit is conducted as a primary function of a value X(i) (i is an integer) of an i-th sample of prediction result data (the total number of samples is made to be n pieces) for a certain voice unit, a gradient of this primary function is α, and an intercept is β. (A unit of gradient α may be [Hertz/sec], and a unit of intercept β may be [Hertz].)

In addition, when the total numbers of samples of prediction result data and pitch component data differ from each other for voice units having the same reading, correlation may be calculated by resampling one (or both) among both after interpolating it by primary interpolation, Lagrange interpolation, or another arbitrary method, and equalizing the total number of both samples.

On the other hand, the voice unit editor 8 calculates a value dt of the right-hand side of Formula 3 using speed initial value data supplied from the utterance speed converter 11, and message template data and utterance speed data which are supplied to the voice unit editor 8. This value dt is a coefficient expressing time difference between the utterance speed of a voice unit which voice unit data express, and the utterance speed of a voice unit in a message template whose reading agrees with this voice unit.
dt=|(Xt−Yt)/Yt|
(where Yt is the utterance speed of a voice unit which voice unit data expresses, and Xt is the utterance speed of a voice unit in a message template whose reading agrees with this voice unit.) Then, the voice unit editor 8 selects data, where a value cost1 (evaluation value) of the right-hand side in Formula 4 becomes maximum, among the voice unit data expressing a voice unit, whose reading agree with a voice unit in a message template, on the basis of the above-described values α and β which are obtained by primary regression, and the above-described coefficient dt.
cost1=1/(W₁|1−α|+W₂|β|+dt)
(where, W₁ and W₂ are predetermined positive coefficients)

The nearer the prediction result of time series change of a frequency of a pitch component of a voice unit, and the time series change of a frequency of a pitch component of the voice unit data expressing a waveform of a voice unit whose reading agrees with this voice unit are, the closer to 1 a value of gradient α becomes, and hence, the value |1−α| becomes close to 0. Then, since the evaluation value cost1 has a form of the reciprocal of a primary function of the value |1−α| in order to make it become a larger value as the correlation between the prediction result of pitch of a voice unit and the pitch of voice unit data becomes high, the evaluation value cost1 becomes a larger value as the value |1−α| becomes close to 0.

On the other hand, voice intonation is characterized by the time series change of a frequency of a pitch component of a voice unit. Hence, a value of gradient α has the property which reflects the difference in voice intonation sensitively.

For this reason, when the accuracy of intonation is important for the voice to be synthesized (i.e., when synthesizing the voice of reading texts such as an E-mail, or the like), it is desirable to enlarge the value of the above-described coefficient W₁ as drastically as possible.

On the contrary, the nearer the prediction result of a fundamental frequency (a base pitch frequency) of a pitch component of a voice unit, and a base pitch frequency of the voice unit data expressing a waveform of a voice unit whose reading agrees with this voice unit are, the closer to 0 the value of intercept β becomes. Hence, the value of intercept β has the property which reflects the difference between base pitch frequencies of voice sensitively. On the other hand, since the evaluation value cost1 has a form which can be also regarded as the reciprocal of a primary function of the value |β|, the evaluation value cost1 becomes a larger value as the value |β| becomes close to 0.

On the other hand, a voice base pitch frequency is a factor which governs a voice speaker's vocal quality, and its difference according to a speaker's gender is also remarkable.

Thus, when the accuracy of a base pitch frequency is important for the voice to be synthesized (i.e., when it is necessary to clarify the gender and vocal quality of a speaker of synthetic speech, or the like), it is desirable to enlarge the value of the above-described coefficient W₂ as drastically as possible.

With returning to the explanation of operation, while selecting voice unit data which expresses a waveform near a waveform of a voice unit in a message template, the voice unit editor 8 extracts a phonogram string, expressing the reading of a voice unit which lacked portion identification data shows, from message template data to supply it to the acoustic processor 4, and instructs it to synthesize a waveform of this voice unit when also receiving lacked portion identification data from the utterance speed converter 11.

The acoustic processor 4 which receives the instruction treats the phonogram string supplied from the voice unit editor 8 similarly to a phonogram string which delivery character string data express. As a result, the compressed waveform data which expresses a voice waveform which the phonograms included in this phonogram string shows is retrieved by the search section 5, and this compressed waveform data is restored by the decompression section 6 into original waveform data to be supplied to the acoustic processor 4 through the search section 5. The acoustic processor 4 supplies this waveform data to the voice unit editor 8.

When waveform data is returned from the acoustic processor 4, the voice unit editor 8 combines this waveform data with what the voice unit editor 8 specifies among the voice unit data supplied from the utterance speed converter 11 in the order according to the alignment of each voice unit within a message template which message template data shows to output them as data which expresses synthetic speech.

In addition, when lacked portion identification data is not included in the data supplied from the utterance speed converter 11, voice unit data which the voice unit editor 8 specifies may be immediately combined with each other in the order according to the alignment of each voice unit within a message template without instructing wave synthesis to the acoustic processor 4 to output them as data which expresses synthetic speech.

In this speech synthesis system explained above, the voice unit data expressing a waveform of a voice unit which can be a larger unit than a phoneme is connected naturally by a sound recording and editing system on the basis of the prediction result of cadence, and the voice of reading a message template is synthesized. Memory capacity of the voice unit database 10 is small in comparison with the case that a waveform is stored every phoneme, and can be searched at high speed. For this reason, this speech synthesis system can be composed in small size and light weight, and can follow high-speed processing.

In addition, when correlation between the prediction result of a wave of a voice unit, and voice unit data is estimated with a plurality of evaluation criteria (for example, evaluation according to a gradient and an intercept at the time of performing primary regression, evaluation according to the time difference between voice units, and the like), it may arise frequently that inconsistency between the results of these evaluations arises. However, the result evaluated in this speech synthesis system with a plurality of evaluation criteria is integrated on the basis of one evaluation value, and proper evaluation is performed.

Furthermore, the structure of this speech synthesis system is not limited to the above-described.

For example, neither waveform data nor voice unit data need to be data in a PCM format, but a data format is arbitrary.

In addition, the waveform database 7 and voice unit database 10 always need to store neither waveform data nor voice unit data, where data compression is performed. When the waveform database 7 and voice unit database 10 store waveform data and voice unit data in the state that data compression is not performed, the body unit M does not need to be equipped with the decompression section 6.

Moreover, the voice unit database creation section 13 may read voice unit data and a phonogram string which become a material of new compressed voice unit data added to the voice unit database 10 through a recording medium drive device from a recording medium set in this recording medium drive device which is not shown.

Furthermore, the voice unit registration unit R does not always need to be equipped with the collected voice unit database storage section 12.

In addition, when the cadence registration data which expresses the cadence of a specific voice unit is stored beforehand and this specific voice unit is included in a message template, the voice unit editor 8 may treat the cadence, which this cadence registration data expresses, as the result of cadence prediction.

Furthermore, the voice unit editor 8 may newly store the result of past cadence prediction as cadence registration data.

Moreover, instead of calculating the above-mentioned values α and β, the voice unit editor 8 About each pitch component data supplied from the utterance speed converter 11 may calculate, for example, totally n values of the value R_{XY}(j) shown in the right-hand side of Formula 5 with letting a value of j be each integer from 0 to n−1, and may also specify a maximum value among n pieces of obtained correlation coefficients from R_{XY}(0) to R_{XY}(n−1).

$${R}_{xy} ( j ) = \frac{{\sum }_{i = 1}^{n} [ \{ X ( i ) - mx \} \cdot \{ Yj ( i ) - my \} ]}{\sqrt{{\sum }_{i = 1}^{n} {\{ X ( i ) - mx \}}^{2} \sqrt{{\sum }_{i = 1}^{n} {\{ Y ( i ) - my \}}^{2}}}}$$

R_{XY}(j) is a value of a correlation coefficient between prediction result data for a certain voice unit (The total number of samples is n. In addition, X(i) in Formula 5 is the same as that in Formula 1), and a sample string obtained by giving a cyclic shift of length j in a fixed direction (in addition, in Formula 5, Yj(i) is a value of the i-th sample of this sample string) to pitch component data (the total number of samples is n) about voice unit data expressing a waveform of a voice unit whose reading agrees with this voice unit.

FIG. 3(b) is a graph showing an example of values of prediction result data and pitch component data which are used in order to obtain values of R_{XY}(0) and R_{XY}(j). Where, a value of Y(p) (where, p is an integer from 1 to n) is a value of the p-th sample of the pitch component data before performing the cyclic shift. Hence, for example, assuming the samples of voice unit data are located in ascending time order and a cyclic shift is performed in a lower direction (that is, in a late time direction), Yj(p)=Y(p−j) in the case of j<p, and, on the other hand, Yj(p)=Y(n−j+p) in 1≦p≦j.

Then, the voice unit editor 8 may select data, where a value cost2 (evaluation value) of the right-hand side in Formula 6 becomes maximum, among the voice unit data expressing a voice unit, whose reading agree with a voice unit in a message template, on the basis of a maximum value of the above-described R_{XY}(j), and the above-described coefficient dt.
cost2=1/(W₃|Rmax|+dt)
(where, W₃ is a predetermined coefficient and Rmax is a maximum value among R_{XY}(0) to R_{XY}(n−1).)

In addition, the voice unit editor 8 does not always need to obtain the above-described correlation coefficient about what are given the cyclic shift to various pitch component data, but, for example, may treat a value of R_{XY}(0) as the maximum value of the correlation coefficient as it is.

Furthermore, the evaluation value cost1 or cost2 does not need to include the item of the coefficient dt, and the voice unit editor 8 does not need to obtain the coefficient dt in this case.

Alternatively, the voice unit editor 8 may use a value of the coefficient dt as an evaluation value as it is, and the voice unit editor does not need to calculate values of a gradient α, an intercept β, and R_{XY}(j) in this case.

In addition, pitch component data may be data which expresses the time series change of pitch length of a voice unit which voice unit data expresses. In this case, the voice unit editor 8 may create the data which expresses the prediction result of time series change of pitch length of a voice unit as prediction result data, and may obtain the correlation between with the pitch component data which expresses the time series change of pitch length of voice unit data which expresses a waveform of a voice unit whose reading agrees with this voice unit.

Furthermore, the voice unit database creation section 13 may be equipped with a microphone, an amplifier, a sampling circuit, and an A/D (Analog-to-Digital) converter, a PCM encoder, and the like. In this case, instead of acquiring voice unit data from the collected voice unit database storage section 12, the voice unit database creation section 13 may create voice unit data by amplifying, sampling, and A/D converting a voice signal which expresses the voice which the own microphone collects, and thereafter, giving PCM modulation to the sampled voice signal.

Moreover, the voice unit editor 8 may make the time length of a waveform, which the waveform data concerned expresses, agree with the speed which utterance speed data shows by supplying the waveform data, returned from the acoustic processor 4, to the utterance speed converter 11.

In addition, the voice unit editor 8 may use voice unit data, which expresses a waveform nearest to a waveform of a voice unit included in a free text which this free text data expresses, for voice synthesis by, for example, acquiring free text data with the language processor 1, and selecting that by performing the processing which is substantially the same as the processing of selecting the voice unit data which expresses a waveform nearest to a waveform of a voice unit included in a message template.

In this case, the acoustic processor 4 does not need to make the search section 5 retrieve the waveform data which expresses a waveform of this voice unit about the voice unit which the voice unit data which the voice unit editor 8 selected expresses. In addition, the voice unit editor 8 reports the voice unit, which the acoustic processor 4 does not need to synthesize, to the acoustic processor 4, and the acoustic processor 4 may respond this report to suspend the retrieval of a waveform of a unit voice which constitutes this voice unit.

In addition, the voice unit editor 8 may use voice unit data, which expresses a waveform nearest to a waveform of a voice unit included in a delivery character string which this delivery character string expresses, for voice synthesis by, for example, acquiring the delivery character string with the acoustic processor 4, and selecting that by performing the processing which is substantially the same as the processing of selecting the voice unit data which expresses a waveform nearest to a waveform of a voice unit included in a message template. In this case, the acoustic processor 4 does not need to make the search section 5 retrieve the waveform data which expresses a waveform of this voice unit about the voice unit which the voice unit data which the voice unit editor 8 selected expresses.

### Second Embodiment

Next, a second embodiment of the present invention will be explained. The physical configuration of a speech synthesis system according to the second embodiment of this invention is substantially the same as the configuration in the first embodiment mentioned above.

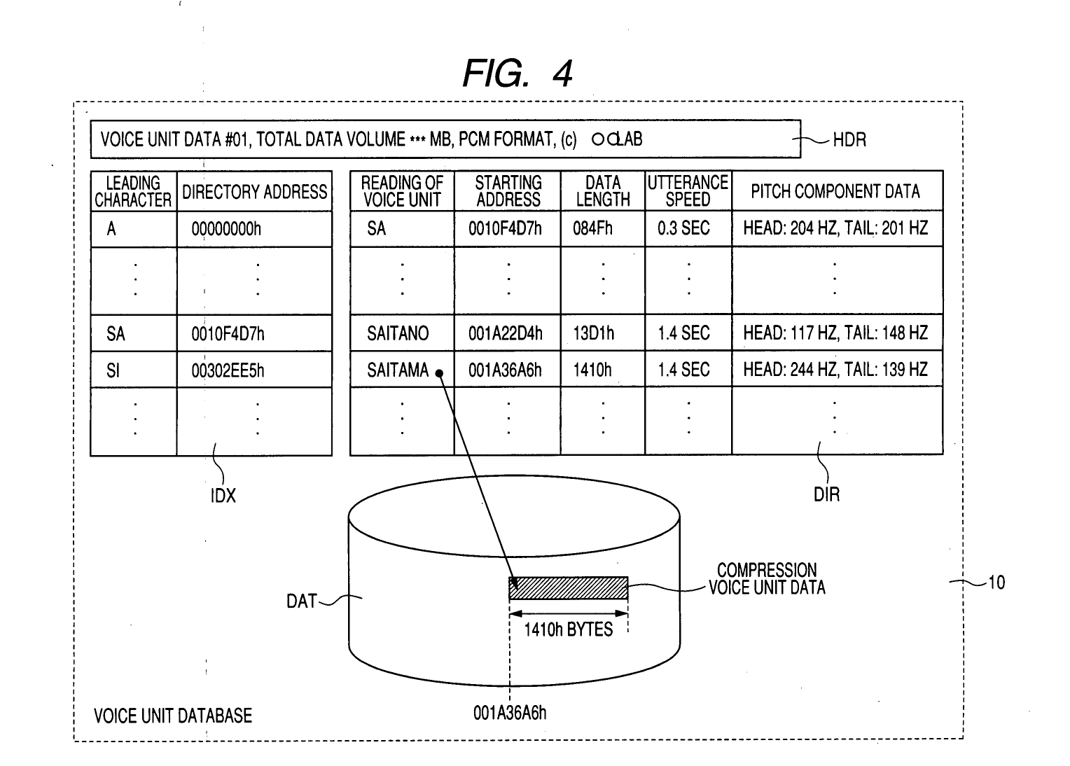

Nevertheless, in the directory section DIR of the voice unit database 10 in the speech synthesis system of the second embodiment, for example, as shown in FIG. 4, the above-described data (A) to (D) are stored with being associated with each other about each compression audio data, and also (F) data which expresses frequencies of pitch components in the head and tail of a voice unit which this compressed voice unit data expresses is stored with being associated with the data of these (A) to (D), instead of the above-mentioned data (E) as pitch component data.

In addition, FIG. 4 exemplifies the case that compressed voice unit data with the data volume of 1410h bytes which expresses a waveform of the voice unit whose reading is “SAITAMA” is stored in a logical position, whose head address is 001A36A6h, similarly to FIG. 2, as data included in the data section DAT. In addition, it is assumed that at least data (A) among the above-described set of data (A) to (D) and (F) is stored in a storage area of the voice unit database 10 in the state of being sorted according to the order determined on the basis of phonograms which voice unit reading data express.

Then, it is assumed that, when reading a phonogram and voice unit data, which are associated with each other, from the collected voice unit database storage section 12, the voice unit database creation section 13 of the voice unit registration unit R specifies the utterance speed of voice, and frequencies of pitch components at a head and a tail of voice which this voice unit data expresses.

Then, when supplying the read voice unit data to the compression section 14 and receiving the return of compressed voice unit data, it writes this compressed voice unit data, a phonogram read from the collected voice unit database storage section 12, a leading address of this compressed voice unit data in a storage area of the voice unit database 10, the data length of this compressed voice unit data, and the speed initial value data which shows a specified utterance speed in the storage area of the voice unit database 10 by performing the same operation as the voice unit database creation section 13 in the first embodiment, and generates the data which shows the result of specifying frequencies of pitch components at a head and a tail of voice to write it in the storage area of the voice unit database 10 as pitch component data.

In addition, the specification of utterance speed and a frequency of a pitch component may be performed, for example, by the substantially same method as the method which the voice unit database creation section 13 of the first embodiment performs.

Next, the operation of this speech synthesis system will be explained.

The operation in the case that the language processor 1 of this speech synthesis system acquires free text data from the outside, and the acoustic processor 4 acquires delivery character string data is the substantially same as the operation which the speech synthesis system of the first embodiment performs. (In addition, both of a method of the language processor 1 acquiring free text data, and a method of the acoustic processor 4 acquiring delivery character string data are arbitrary, and for example, free text data or delivery character string data may be acquired by the methods which are the same as the methods of the language processor 1 and the acoustic processor 4 in the first embodiment performing.)

Next, it is assumed that the voice unit editor 8 acquires message template data and utterance speed data. In addition, since the method by which the voice unit editor 8 acquires message template data and utterance speed data is also arbitrary, message template data and utterance speed data may be acquired, for example, by a method which is the same as the method by which the voice unit editor 8 of the first embodiment performs.

When message template data and utterance speed data are supplied to the voice unit editor 8, similarly to the voice unit editor 8 in the first embodiment, the voice unit editor 8 instructs the search section 9 to retrieve all the compressed voice unit data with which phonograms agreeing with phonograms which express the reading of a voice unit included in a message template are associated. In addition, similarly to the voice unit editor 8 in the first embodiment, the voice unit editor 8 also instructs the utterance speed converter 11 to convert the voice unit data supplied to the utterance speed converter 11 to make the time length of the voice unit, which the voice unit data concerned expresses, coincide with the speed which utterance speed data shows.

Then, the search section 9, decompression section 6, and utterance speed converter 11 perform the substantially same operation as the operation of the search section 9, decompression section 6, and utterance speed converter 11 in the first embodiment, and in consequence, voice unit data, voice unit reading data, and pitch component data are supplied to the voice unit editor 8 from the utterance speed converter 11. In addition, when lacked portion identification data are supplied to the utterance speed converter 11 from the search section 9, this lacked portion identification data are also further supplied to the voice unit editor 8.

When receiving the voice unit data, voice unit reading data, speed initial value data, and pitch component data from the utterance speed converter 11, the voice unit editor 8 selects one piece of voice unit data expressing a waveform, which can be most approximate to a waveform of the voice unit which constitutes a message template, every voice unit from among the supplied voice unit data.

Specifically, first, the voice unit editor 8 specifies frequencies of a pitch component at a head and a tail of each voice unit data supplied from the utterance speed converter 11 on the basis of the pitch component data supplied from the utterance speed converter 11. Then, from among the voice unit data supplied from the utterance speed converter 11, voice unit data is selected so as to fulfill such a condition that a value obtained by accumulating absolute values of difference between frequencies of pitch components in boundary of adjacent voice units within a message template over whole message template becomes minimum.

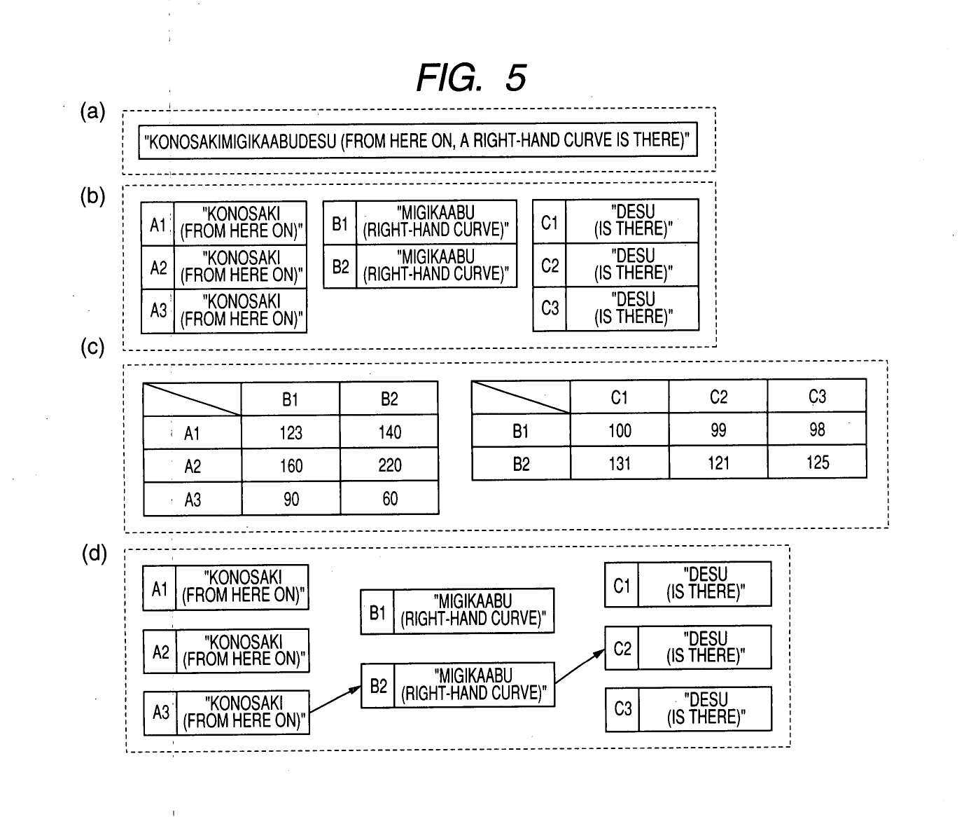

The conditions for selecting voice unit data will be explained with reference to FIGS. 5(a) to 5(d). For example, it is assumed that the message template data which expresses a message template whose reading is “KONOSAKIMIGIKAABUDESU (From now on, a right-hand curve is there)” as shown in FIG. 5(a) is supplied to the voice unit editor 8, and that this message template is composed of three voice units of “KONOSAKI”, and “MIGIKAABU”, and “DESU”. Then, as a list is shown in FIG. 5(b), it is assumed that from the voice unit database 10, three pieces of compressed voice unit data whose reading is “KONOSAKI” (data which is expressed as “A1”, “A2”, or “A3” in FIG. 5(b)), two pieces of compressed voice unit data whose reading is “MIGIKAABU” (data which is expressed as “B1” or “B2” in FIG. 5(b)), two pieces of compressed voice unit data whose reading is “DESU” (data which is expressed as “C1”, “C2”, or “C3” in FIG. 5(b)) were retrieved, decompressed, and supplied to the voice unit editor 8 as voice unit data, respectively.

On the other hand, it is assumed that an absolute value of difference between a frequency of a pitch component at a tail of each voice unit which each voice unit data whose reading was “KONOSAKI” expressed, and a frequency of a pitch component at a head of each voice unit which each voice unit data whose reading was “MIGIKAABU” expressed was as shown in FIG. 5(c). (FIG. 5(c) shows, for example, that an absolute value of difference between a frequency of a pitch component at the tail of a voice unit which the voice unit data A1 expresses, and a frequency of a pitch component at the head of a voice unit which the voice unit data B1 expresses shows “123”. In addition, a unit of this absolute value is “Hertz”, for example.)

In addition, it is assumed that an absolute value of difference between a frequency of a pitch component at a tail of each voice unit which each voice unit data whose reading was “MIGIKAABU” expressed, and a frequency of a pitch component at a head of each voice unit which each voice unit data whose reading was “DESU” expressed was as shown in FIG. 5(c).

In this case, when a waveform of the voice which reads out the message template “KONOSAKIMIGIKAABUDESU” is generated using voice unit data, the combination that the accumulating total of absolute values of difference between frequencies of pitch components in a boundary of adjacent voice units becomes minimum is the combination of A3, B2, and C2. Hence, in this case, the voice unit editor 8 selects voice unit data A3, B2, and C2, as shown in FIG. 5(d).

In order to select the voice unit data which fulfills this condition, the voice unit editor 8 may define, for example, an absolute value of difference between frequencies of pitch components in a boundary of adjacent voice units within a message template as distance, and may select the voice unit data by a method of DP (Dynamic Programming) matching.

On the other hand, when also receiving lacked portion identification data from the utterance speed converter 11, the voice unit editor 8 extracts a phonogram string, expressing the reading of a voice unit which lacked portion identification data shows, from message template data to supply it to the acoustic processor 4, and instructs it to synthesize a waveform of this voice unit.

The acoustic processor 4 which receives the instruction treats the phonogram string supplied from the voice unit editor 8 similarly to a phonogram string which delivery character string data express. As a result, the compressed waveform data which expresses a voice waveform which the phonograms included in this phonogram string shows is retrieved by the search section 5, and this compressed waveform data is restored by the decompression section 6 into original waveform data to be supplied to the acoustic processor 4 through the search section 5. The acoustic processor 4 supplies this waveform data to the voice unit editor 8.

When waveform data is returned from the acoustic processor 4, the voice unit editor 8 combines this waveform data with what the voice unit editor 8 selects among the voice unit data supplied from the utterance speed converter 11 in the order according to the alignment of each voice unit within a message template which message template data shows to output them as data which expresses synthetic speech.

In addition, when lacked portion identification data is not included in the data supplied from the utterance speed converter 11, similarly to the first embodiment, voice unit data which the voice unit editor 8 selects may be immediately combined with each other in the order according to the alignment of each voice unit within a message template without instructing wave synthesis to the acoustic processor 4 to output them as data which expresses synthetic speech.

As explained above, in the speech synthesis system of this second embodiment, since voice unit data is selected so that an accumulating total of amounts of discrete changes of frequencies of pitch components in a boundary of voice unit data may become minimum over a whole message template and they are connected naturally by the sound recording and editing system, synthetic speech becomes natural. In addition, in this speech synthesis system, since cadence prediction with complicated processing is not performed, it is also possible to follow high-speed processing with simple configuration.

In addition, also the speech synthesis structure of a system of this second embodiment is not limited to the above-described.

Furthermore, pitch component data may be data which expresses the pitch lengths at a head and a tail of a voice unit which voice unit data expresses. In this case, the voice unit editor 8 may specify pitch lengths at a head and a tail of each voice unit data supplied from the utterance speed converter 11 on the basis of the pitch component data supplied from the utterance speed converter 11, and may select voice unit data so as to fulfill such a condition that a value obtained by accumulating absolute values of difference between pitch lengths of pitch components in a boundary of adjacent voice units within a message template over a whole message template becomes minimum.

Moreover, the voice unit editor 8 may use voice unit data, which expresses a waveform which can be regarded as a waveform of a voice unit included in a free text which this free text data expresses, for voice synthesis by, for example, acquiring the free text data with the language processor 1, and extracting that by performing the processing which is substantially the same as the processing of extracting the voice unit data which expresses a waveform which can be regarded as a waveform of a voice unit included in a message template.

In this case, the acoustic processor 4 does not need to make the search section 5 retrieve the waveform data which expresses a waveform of this voice unit about the voice unit which the voice unit data which the voice unit editor 8 extracted expresses. In addition, the voice unit editor 8 reports the voice unit, which the acoustic processor 4 does not need to synthesize, to the acoustic processor 4, and the acoustic processor 4 may respond this report to suspend the retrieval of a waveform of a unit voice which constitutes this voice unit.

In addition, the voice unit editor 8 may use voice unit data, which expresses a waveform which can be regarded as a waveform of a voice unit included in a delivery character string which this delivery character string expresses, for voice synthesis by, for example, acquiring the delivery character string with the acoustic processor 4, and extracting that by performing the processing which is substantially the same as the processing of extracting the voice unit data which expresses a waveform which can be regarded as a waveform of a voice unit included in a message template. In this case, the acoustic processor 4 does not need to make the search section 5 retrieve the waveform data which expresses a waveform of this voice unit about the voice unit which the voice unit data which the voice unit editor 8 extracted expresses.

### Third Embodiment

Next, a third embodiment of the present invention will be explained. The physical configuration of a speech synthesis system according to the third embodiment of this invention is substantially the same as the configuration in the first embodiment mentioned above.

Next, the operation of this speech synthesis system will be explained.

The operation in the case that the language processor 1 of this speech synthesis system acquires free text data from the outside, and that the acoustic processor 4 acquires delivery character string data is the substantially same as the operation which the speech synthesis system of the first or second embodiment performs. (In addition, both of a method of the language processor 1 acquiring free text data, and a method of the acoustic processor 4 acquiring delivery character string data are arbitrary, and for example, free text data or delivery character string data may be acquired by the methods which are the same as the methods of the language processor 1 and the acoustic processor 4 in the first or second embodiment performing.)

Next, it is assumed that the voice unit editor 8 acquires message template data and utterance speed data. In addition, since the method by which the voice unit editor 8 acquires message template data and utterance speed data is also arbitrary, message template data and utterance speed data may be acquired, for example, by a method which is the same as the method by which the voice unit editor 8 of the first embodiment performs. Alternatively, when this speech synthesis system forms a part of an intra-vehicle system such as a car-navigation system, and another device constituting this intra-vehicle system (i.e., a device which performs speech recognition and executes agent processing on the basis of the information obtained as the result of the speech recognition) determine the contents and utterance speed of speaking to a user and generates the data which expresses determination result, this speech synthesis system may receive (acquire) this generated data, and may treat it as message template data and utterance speed data.

When message template data and utterance speed data are supplied to the voice unit editor 8, similarly to the voice unit editor 8 in the first embodiment, the voice unit editor 8 instructs the search section 9 to retrieve all the compressed voice unit data with which phonograms agreeing with phonograms which express the reading of a voice unit included in a message template are associated. In addition, similarly to the voice unit editor 8 in the first embodiment, the voice unit editor 8 also instructs the utterance speed converter 11 to convert the voice unit data supplied to the utterance speed converter 11 to make the time length of the voice unit, which the voice unit data concerned expresses, coincide with the speed which utterance speed data shows.

Then, the search section 9, decompression section 6, and utterance speed converter 11 perform the substantially same operation as the operation of the search section 9, decompression section 6, and utterance speed converter 11 in the first embodiment, and in consequence, voice unit data, voice unit reading data, speed initial value data which expresses the utterance speed of a voice unit which this voice unit data expresses, and pitch component data are supplied to the voice unit editor 8 from the utterance speed converter 11. In addition, when lacked portion identification data is supplied to the utterance speed converter 11 from the search section 9, this lacked portion identification data is also further supplied to the voice unit editor 8.

When receiving voice unit data, voice unit reading data, and pitch component data from the utterance speed converter 11, the voice unit editor 8 calculates a set of the above-described values α and β, and/or Rmax about each pitch component data supplied from the utterance speed converter 11, and calculates the above-described value dt using this speed initial value data, and message template data and utterance speed data which are supplied to the voice unit editor 8.

Then, the voice unit editor 8 specifies values of α, β, Rmax, and dt about the voice unit data (hereafter, this is describes as voice unit data X) concerned which itself calculated, and an evaluation value H_{XY} shown in Formula 7 on the basis of a frequency of a pitch component of the voice unit data (hereafter, this is described as voice unit data Y) which expresses an adjacent voice unit after the voice unit which the voice unit data concerned within a message template, about each voice unit data supplied from the utterance speed converter 11.
H_{XY}=(W_{A}*cost_{—}A)+(W_{B}*cost_{—}B)+(W_{C}*cost_{—}C)
(Where, it is assumed that each of W_{A}, W_{B}, and W_{C} is a predetermined coefficient, and W_{A} is not 0)

The value cost_A included in the right-hand side of Formula 7 is a reciprocal of an absolute value of difference of frequencies of pitch components in a boundary between the voice unit which voice unit data X expresses and the voice unit which the voice unit data Y expresses, which are adjacent to each other within the message template concerned.

In addition, in order to specify a value of cost_A, the voice unit editor 8 may specify frequencies of pitch components at a head and a tail of each voice unit data supplied from the utterance speed converter 11 on the basis of the pitch component data supplied from the utterance speed converter 11.

Furthermore, a value cost_B included in the right-hand side of Formula 7 is a value at the time of calculating an evaluation value cost_B according to Formula 8 about the voice unit data X.
cost_{—}B=1/(W_{B1}|1−α|+W_{B2}|β|+W_{B3}*dt)
(Where, W_{B1}, W_{B2}, and W_{B3} are predetermined positive coefficients.)

In addition, the value cost_C included in the right-hand side of Formula 7 is a value at the time of calculating an evaluation value cost_C according to Formula 9 about the voice unit data X.
cost_{—}C=1/(W_{c1}|Rmax|+W_{c2}*dt)
(where, W_{c1} and W_{c2} are predetermined coefficients.)

Alternatively, the voice unit editor 8 may specify the evaluation value H_{XY} according to Formulas 10 and 11 instead of Formulas 7 to 9. Nevertheless, in regard to cost_B and cost_C which are included in Formula 10, each value of the above-described coefficients W_{B3} and W_{c3} is made 0. In addition, items (W_{B3}*dt) and (W_{c2}*dt) in Formulas 8 and 9 may not be provided.
H_{XY}=(W_{A}*cost_{—}A)+(W_{B}*cost_{—}B)+(W_{c}*cost_{—}C)+(W_{D}*cost_{—}D)
(Where, W_{D} is a predetermined coefficient which is not 0.)
cost_{—}D=1/(W_{d1}*dt))
(Where, W_{d1} is a predetermined coefficient which is not 0.)

Then, the voice unit editor 8 selects the combination, where the sum total of evaluation values H_{XY} of respective voice unit data belonging to combination becomes maximum, as the combination of optimal voice unit data for synthesizing the voice which reads out a message template among respective combinations obtained by selecting one piece of voice unit data per one voice unit which constitutes a message template which the message template data supplied to the voice unit editor 8 expresses from among respective voice unit data supplied from the utterance speed converter 11.

Thus, for example, as shown in FIG. 5, when a message template which message template data expresses is composed of voice units A, B, and C, voice unit data A1, A2, and A3 are retrieved as candidates of a voice unit data which expresses the voice unit A, voice unit data B1, and B2 are retrieved as candidates of a voice unit data which expresses the voice unit B, and voice unit data C1, C2, and C3 are retrieved as candidates of a voice unit data which expresses the voice unit C, a combination, where the sum total of the evaluation values H_{XY} of respective voice unit data belonging to the combinations becomes maximum, among eighteen kinds of combinations totally obtained by selecting one piece from among the voice unit data A1, A2, and A3, one piece from among the voice unit data B1 and B2, and one piece from among the voice unit data C1, C2, and C3, that is, three pieces in total, is selected as the combination of optimal voice unit data for synthesizing the voice which reads out the message template.

Nevertheless, it is assumed that, as the evaluation value H_{XY} used for calculating sum total, what reflected the connecting relation of voice units within the combination correctly is selected. Thus, it is assumed that, for example, when the voice unit data P which expresses voice unit p, and the voice unit data Q which expresses voice unit q are included in combinations, and the voice unit p adjacently precedes the voice unit q in a message template, an evaluation value H_{PQ} at the time of the voice unit p adjacently preceding the voice unit q is used as an evaluation value of the voice unit data P.

In addition, about a voice unit at the tail of a message template (i.e., in the example mentioned above with reference to FIG. 5, the voice units C1, C2, and C3), since a following voice unit does not exist, a value of cost_A cannot be determined. For this reason, when calculating an evaluation value H_{XY} of the voice unit data which expresses these voice units at tails, the voice unit editor 8 treats a value of (W_{A}*cost_A) as what is 0, and on the other hand, treats values of coefficients W_{B}, W_{C}, and W_{D} as what are predetermined values different from the case of calculating evaluation values H_{XY} of other voice unit data.

Moreover, the voice unit editor 8 may specify an evaluation value H_{XY} as what includes an evaluation value which expresses the relationship between with a voice unit data Y adjacently preceding a voice unit which the voice unit data X concerned expresses, about the voice unit data X using Formula 7 or 11. In this case, since a voice unit preceding a voice unit at the head of a message template does not exist, a value of cost_A cannot be determined. For this reason, when calculating an evaluation value H_{XY} of the voice unit data which expresses these voice units at heads, the voice unit editor 8 may treat a value of (W_{A}*cost_A) as what is 0, and on the other hand, may treat values of coefficients W_{B}, W_{C}, and W_{D} as what are predetermined values different from the case of calculating evaluation values H_{XY} of other voice unit data.

On the other hand, when also receiving lacked portion identification data from the utterance speed converter 11, the voice unit editor 8 extracts a phonogram string, expressing the reading of a voice unit which lacked portion identification data shows, from message template data to supply it to the acoustic processor 4, and instructs it to synthesize a waveform of this voice unit.

The acoustic processor 4 which receives the instruction treats the phonogram string supplied from the voice unit editor 8 similarly to a phonogram string which delivery character string data express. As a result, the compressed waveform data which expresses a voice waveform which the phonograms included in this phonogram string shows is retrieved by the search section 5, and this compressed waveform data is restored by the decompression section 6 into original waveform data to be supplied to the acoustic processor 4 through the search section 5. The acoustic processor 4 supplies this waveform data to the voice unit editor 8.

When waveform data is returned from the acoustic processor 4, the voice unit editor 8 combines this waveform data with what belongs to a combination which the voice unit editor 8 selects as a combination, where the sum total of evaluation values H_{XY} becomes maximum, among the voice unit data supplied from the utterance speed converter 11 in the order according to the alignment of each voice unit within a message template which message template data shows to output them as data which expresses synthetic speech.

In addition, when lacked portion identification data is not included in the data supplied from the utterance speed converter 11, similarly to the first embodiment, voice unit data which the voice unit editor 8 selects may be immediately combined with each other in the order according to the alignment of each voice unit within a message template without instructing wave synthesis to the acoustic processor 4 to output them as data which expresses synthetic speech.

As explained above, also in this speech synthesis system, the voice unit data is connected naturally by the sound recording and editing system, and the voice of reading a message template is synthesized. Memory capacity of the voice unit database 10 is small in comparison with the case that a waveform is stored every phoneme, and can be searched at high speed. For this reason, this speech synthesis system can be composed in small size and light weight, and can follow high-speed processing.

Then, according to the speech synthesis system of the third embodiment, various evaluation criteria for evaluating the appropriateness of combination of voice unit data selected in order to synthesize the voice of reading out a message template (i.e., evaluation with a gradient and an intercept at the time of performing primary regression of the correlation between the prediction result of a waveform of a voice unit, and voice unit data, evaluation with the time difference between voice units, accumulating total of amount of discrete change of frequencies of pitch components in a boundary between voice unit data, or the like) is synthetically reflected in the form of affecting one evaluation value, and as a result, the optimal combination of voice unit data to be selected in order to synthesize the most natural synthetic speech is determined properly.

In addition, the structure of the speech synthesis system of this third embodiment is not limited to the above-described.

For example, evaluation values which the voice unit editor 8 uses in order to select the optimal combination of voice unit data are not limited to what are shown in Formulas 7 to 13, but they may be arbitrary values expressing evaluation about whether the voice obtained by combining voice unit, which voice unit data expresses, with each other is similar to or different from human voice in what extent.

In addition, variables or constants included in a formula (evaluation expression) which express an evaluation value are not always limited to what are included in Formulas 7 to 13, but, as an evaluation expression, a formula including arbitrary parameters showing features of a voice unit which voice unit data expresses, arbitrary parameters showing features of voice obtained by combining the voice unit concerned with each other, or arbitrary parameters showing features predicted to be provided in the voice concerned when a person utters the voice concerned may be used.

Furthermore, it is not necessary that a criterion for selecting the optimal combination of voice unit data can be expressed in the form of an evaluation value, but it is arbitrary as long as it is such as a criterion to specify the optimal combination of voice unit data on the basis of evaluation about whether the voice obtained by combining voice units, which voice unit data expresses, with each other is similar to or different from the voice, which a person utters, in what extent.

Moreover, the voice unit editor 8 may use voice unit data, which expresses a waveform nearest to a waveform of a voice unit included in a free text which this free text data expresses, for voice synthesis by, for example, acquiring the free text data with the language processor 1, and extracting that by performing the processing which is substantially the same as the processing of extracting the voice unit data which expresses a waveform which is regarded as a waveform of a voice unit included in a message template. In this case, the acoustic processor 4 does not need to make the search section 5 retrieve the waveform data which expresses a waveform of this voice unit about the voice unit which the voice unit data which the voice unit editor 8 extracted expresses. In addition, the voice unit editor 8 reports the voice unit, which the acoustic processor 4 does not need to synthesize, to the acoustic processor 4, and the acoustic processor 4 may respond this report to suspend the retrieval of a waveform of a unit voice which constitutes this voice unit.

In addition, the voice unit editor 8 may use voice unit data, which expresses a waveform which can be regarded as a waveform of a voice unit included in a delivery character string which this delivery character string expresses, for voice synthesis by, for example, acquiring the delivery character string with the acoustic processor 4, and extracting that by performing the processing which is substantially the same as the processing of extracting the voice unit data which expresses a waveform which can be regarded as a waveform of a voice unit included in a message template. In this case, the acoustic processor 4 does not need to make the search section 5 retrieve the waveform data which expresses a waveform of this voice unit about the voice unit which the voice unit data which the voice unit editor 8 extracted expresses.

As mentioned above, although the embodiments of this invention are explained, a voice data selector related to this invention is not based on a dedicated system, but is feasible using a normal computer system.

For example, by installing programs in a personal computer from a medium (CD-ROM, MO, a floppy (registered trademark) disk, or the like) which stores the programs for executing the operation of the language processor 1, general word dictionary 2, user word dictionary 3, acoustic processor 4, search section 5, decompression section 6, waveform database 7, voice unit editor 8, search section 9, voice unit database 10, and utterance speed converter 11 in the above-described first embodiment, it becomes possible to make the personal computer concerned function as the body unit M of the above-described first embodiment.

In addition, by installing programs in a personal computer from a medium which stores the programs for executing the operation of the collected voice unit database storage section 12, voice unit database creation section 13, and compression section 14 in the above-described first embodiment, it becomes possible to make the personal computer concerned function as the voice unit registration unit R of the above-described first embodiment.

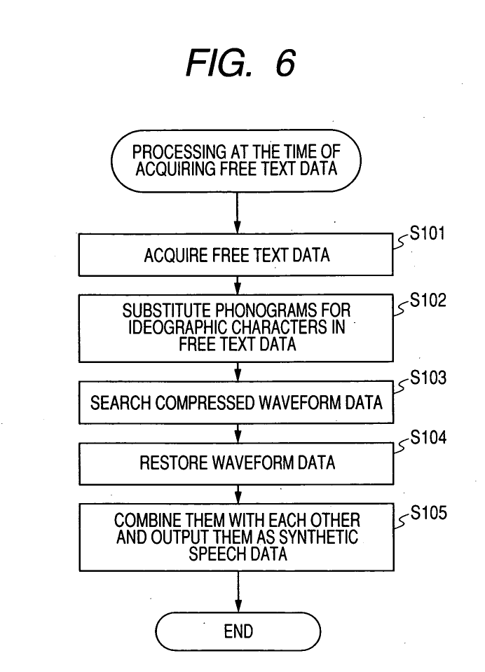

Then, it is assumed that a personal computer which executes these programs to function as the body unit M and voice unit registration unit R in first embodiment perform the processing shown in FIGS. 6 to 8 as the processing corresponding to the operation of the speech synthesis system in FIG. 1.

FIG. 6 is a flowchart showing the processing in the case that this personal computer acquires free text data.

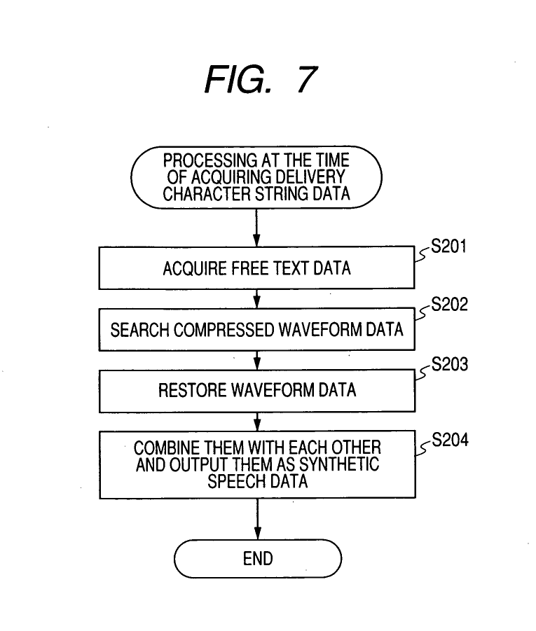

FIG. 7 is a flowchart showing the processing in the case that this personal computer acquires delivery character string data.

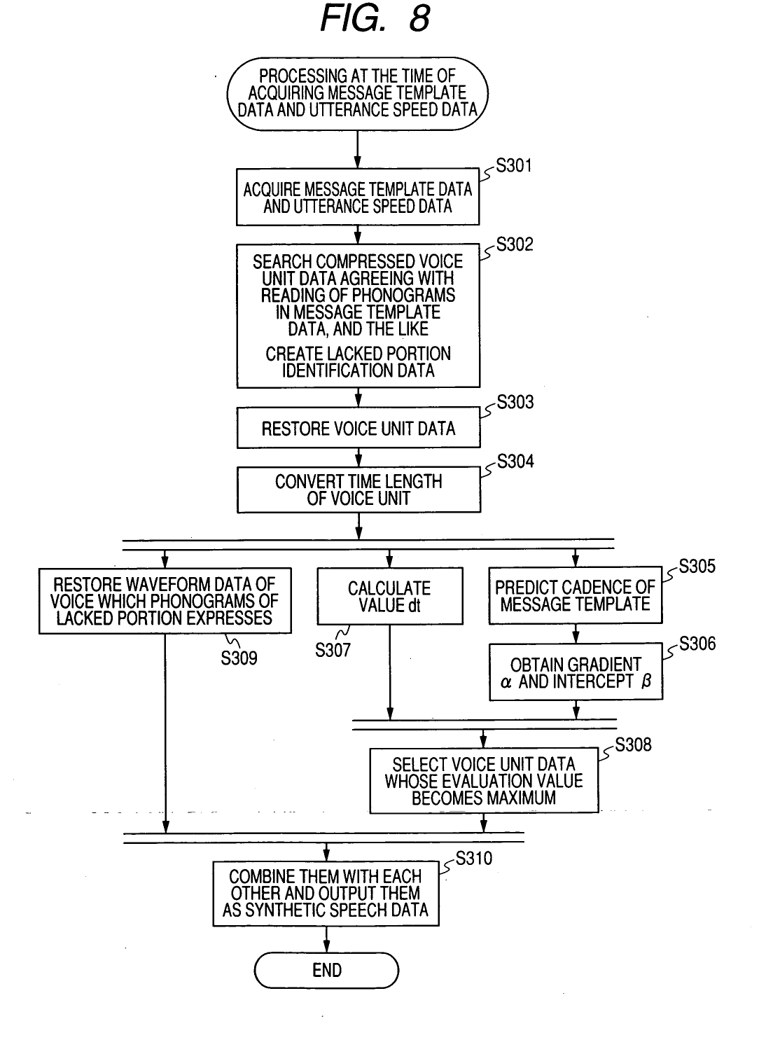

FIG. 8 is a flowchart showing the processing in the case that a personal computer acquires template message data and utterance speed data.

Thus, first, when acquiring the above-described free text data from the outside (step S101 in FIG. 6), this personal computer specifies phonograms, which express the reading, by searching the general word dictionary 2 and user word dictionary 3 about respective ideographic characters which are included in a free text data which this free text data expresses to substitute these ideographic characters for the phonogram to be specified (step S102). In addition, a method of this personal computer acquiring free text data is arbitrary.

Then, when a phonogram string which expresses the result of substituting all the ideographic characters in a free text to phonograms is obtained, this personal computer searches a waveform of a unit voice, which the phonogram concerned expresses, from the waveform database 7 about each phonogram included in this phonogram string to retrieve compressed waveform data which expresses a waveform of the unit voice which each phonogram included in the phonogram string expresses (step S103).

Next, this personal computer restores the compressed waveform data, which is retrieved, to waveform data before being compressed (step S104), and combines the restored waveform data with each other in the order according to the alignment of each phonogram within the phonogram string to output them as synthetic speech data (step S105). In addition, a method of this personal computer outputting synthetic speech data is arbitrary.

In addition, when acquiring the above-described delivery character string data from the outside with an arbitrary method (step S201 in FIG. 7), this personal computer searches a waveform of a unit voice, which the phonogram concerned expresses, from the waveform database 7 about each phonogram included in a phonogram string which this phonogram string expresses to retrieve compressed waveform data which expresses a waveform of the unit voice which each phonogram included in the phonogram string expresses (step S202).

Next, this personal computer restores the compressed waveform data, which is retrieved, to waveform data before being compressed (step S203), and combines the restored waveform data with each other in the order according to the alignment of each phonogram within a phonogram string to output them as synthetic speech data by the processing similar to the processing at step S105 (step S204).

On the other hand, when acquiring the above-described message template data and utterance speed data from the outside by an arbitrary method (step S301 in FIG. 8), this personal computer first retrieves all the compressed voice unit data with which the phonogram which agrees with the phonogram expresses the reading of a voice unit included in the message template which this message template data expresses is associated (step S302).

In addition, at step S302, the above-described voice unit reading data, speed initial value data, and pitch component data which are associated with applicable compressed voice unit data are also retrieved. In addition, when a plurality of compressed voice unit data is applicable to one voice unit, all applicable compressed voice unit data are retrieved. On the other hand, when there exists a voice unit for which compressed voice unit data is not retrieved, the above-described lacked portion identification data is generated.

Next, this personal computer restores the retrieved compressed voice unit data to voice unit data before being compressed (step S303).

Then, it converts the restored voice unit data by the same processing as the processing which the above-described voice unit editor 8 performs to make the time length of the voice unit, which the voice unit data concerned express, agree with the speed which utterance speed data shows (step S304). In addition, when utterance speed data are not supplied, it is not necessary to convert the restored voice unit data.

Next, this personal computer selects per voice unit one piece of voice unit data which expresses a waveform nearest to a waveform of a voice unit which constitutes a message template from among the voice unit data, where the time length of a voice unit is converted, by performing the same processing as the processing which the above-described voice unit editor 8 performs (steps S305 to S308).

Thus, this personal computer predicts the cadence of this message template by performing the analysis of a message template, which message template data expresses, on the basis of a method of cadence prediction (step S305). Then, it obtains the correlation between the prediction result of the time series change of a frequency of a pitch component of this voice unit, and pitch component data which expresses the time series change of a frequency of a pitch component of voice unit data which expresses a waveform of a voice unit whose reading agrees with this voice unit, for each voice unit in a message template (step S306). More specifically, it calculates, for example, values of the above-mentioned gradient α and intercept β about each pitch component data retrieved.

On the other hand, this personal computer calculates the above-described value dt using the retrieved speed initial value data, and the message template data and utterance speed data which are acquired from the outside (step S307).

Then, this personal computer selects what the above-described evaluation value cost1 becomes maximum, among the voice unit data which expresses the voice unit which agrees with the reading of a voice unit in a message template on the basis of the values of α and β calculated at step S306, and the value of dt calculated at step S307 (step S308).

In addition, this personal computer may calculate the maximum value of the above-mentioned R_{XY}(j) instead of calculating the above-mentioned values of α and β at step S306. In this case, it may select at step S308 what the above-described evaluation value cost2 becomes maximum, among the voice unit data which expresses the voice unit which agrees with the reading of a voice unit in a message template on the basis of the maximum value of R_{XY}(j), and the coefficient dt calculated at step S307.

On the other hand, when lacked portion identification data is generated, this personal computer extracts a phonogram string, which expresses the reading of a voice unit which the lacked portion identification data shows, from message template data, restores waveform data which expresses a waveform of voice which each phonogram within this phonogram string shows by performing the processing at the above-described steps S202 to S203 with treating this phonogram string every phoneme similarly to the phonogram string which delivery character string data expresses (step S309).

Then, this personal computer combines the restored waveform data and voice unit data, selected at step S308, with each other in the order according to the alignment of each voice unit within the message template which message template data shows to output them as data which expresses synthetic speech (step S310).

In addition, by installing programs in a personal computer from a medium which stores the programs for executing the operation of the language processor 1, general word dictionary 2, user word dictionary 3, acoustic processor 4, search section 5, decompression section 6, waveform database 7, voice unit editor 8, search section 9, voice unit database 10, and utterance speed converter 11 in the above-described second embodiment, it becomes possible to make the personal computer concerned function as the body unit M of the above-described second embodiment.

Furthermore, by installing programs in a personal computer from a medium which stores the programs for executing the operation of the collected voice unit database storage section 12, voice unit database creation section 13, and compression section 14 in the above-described second embodiment, it becomes possible to make the personal computer concerned function as the voice unit registration unit R of the above-described second embodiment.

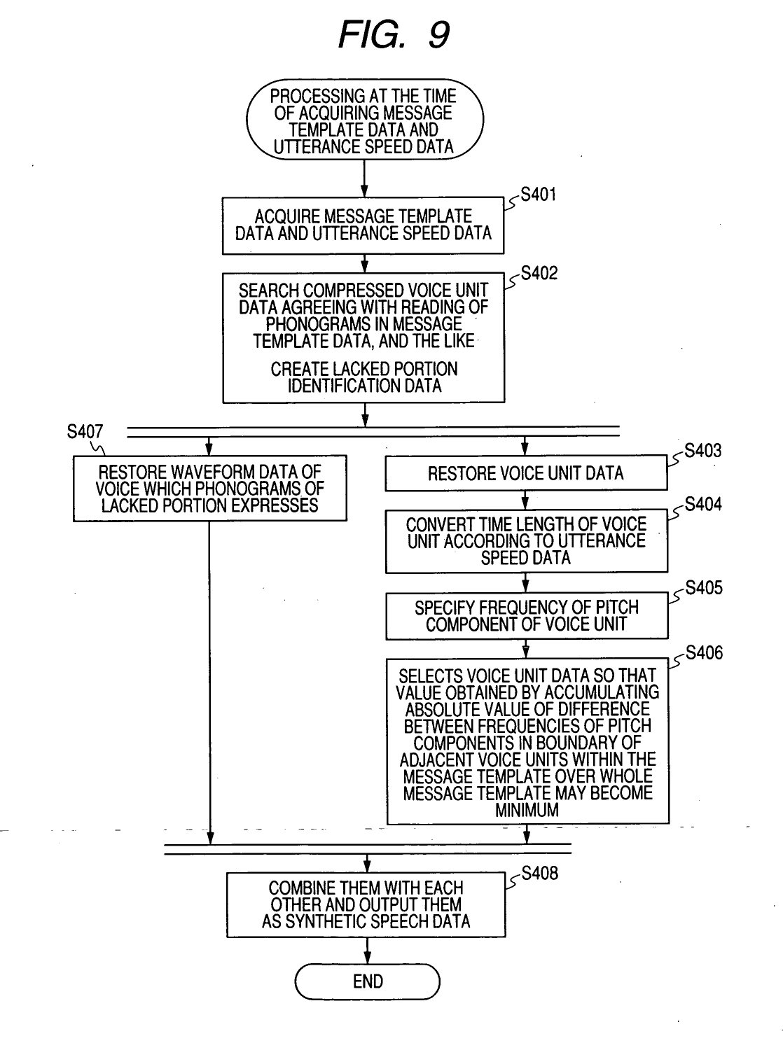

Then, it is assumed that a personal computer which executes these programs to function as the body unit M and voice unit registration unit R in the second embodiment performs the processing shown in FIGS. 6 and 7 as the processing corresponding to the operation of the speech synthesis system in FIG. 1, and further performs the processing shown in FIG. 9.

FIG. 9 is a flowchart showing the processing in the case that this personal computer acquires template message data and utterance speed data.

That is, when acquiring the above-described message template data and utterance speed data from the outside by an arbitrary method (step S401 in FIG. 9), similarly to the above-mentioned processing at step S302, this personal computer first retrieves all the compressed voice unit data with which the phonogram which agrees with the phonogtam expresses the reading of a voice unit included in the message template which this message template data expresses is associated, the above-described voice unit reading data, speed initial value data, and pitch component data which are associated with applicable compressed voice unit data (step S402). In addition, also at step S402, when a plurality of compressed voice unit data is applicable to one voice unit, all applicable compressed voice unit data are retrieved, and on the other hand, when there exists a voice unit for which compressed voice unit data is not retrieved, the above-described lacked portion identification data is generated.

Next, this personal computer restores the retrieved compressed voice unit data to voice unit data before being compressed (step S403), and converts the restored voice unit data by the same processing as the processing which the above-described voice unit editor 8 performs to make the time length of the voice unit, which the voice unit data concerned express, agree with the speed which the utterance speed data shows (step S404). In addition, when utterance speed data is not supplied, it is not necessary to convert the restored voice unit data.

Next, this personal computer selects per voice unit one piece of voice unit data which expresses a waveform which is regarded as a waveform of a voice unit which constitutes a message template from among the voice unit data, where the time length of a voice unit is converted, by performing the same processing as the processing which the above-described voice unit editor 8 in the second embodiment performs (steps S405 to S406).

Specifically, this personal computer first specifies frequencies of pitch components at the head and tail of each voice unit data where the time length of a voice unit is converted on the basis of the retrieved pitch component data (step S405). Then, it selects voice unit data from among these voice unit data so as to fulfill such condition that a value obtained by accumulating absolute values of difference between frequencies of pitch components in boundary of adjacent voice units within a message template over whole message template may become minimum (step S406). In order to select the voice unit data which fulfill this condition, this personal computer may define, for example, an absolute value of difference between frequencies of pitch components in a boundary of adjacent voice units within a message template as distance, and may select the voice unit data by a method of DP matching.

On the other hand, when lacked portion identification data is generated, this personal computer extracts a phonogram string, which expresses the reading of a voice unit which the lacked portion identification data shows, from message template data, restores waveform data which expresses a waveform of voice which each phonogram within this phonogram string shows by performing the processing at the above-described steps S202 to S203 with treating this phonogram string every phoneme similarly to the phonogram string which delivery character string data expresses (step S407).

Then, this personal computer combines the restored waveform data and voice unit data, selected at step S406, with each other in the order according to the alignment of each voice unit within the message template which message template data shows to output them as data which expresses synthetic speech (step S408).

In addition, by installing programs in a personal computer from a medium which stores the programs for executing the operation of the language processor 1, general word dictionary 2, user word dictionary 3, acoustic processor 4, search section 5, decompression section 6, waveform database 7, voice unit editor 8, search section 9, voice unit database 10, and utterance speed converter 11 in the above-described third embodiment, it becomes possible to make the personal computer concerned function as the body unit M of the above-described third embodiment.

Furthermore, by installing programs in a personal computer from a medium which stores the programs for executing the operation of the collected voice unit database storage section 12, voice unit database creation section 13, and compression section 14 in the above-described third embodiment, it becomes possible to make the personal computer concerned function as the voice unit registration unit R of the above-described third embodiment.

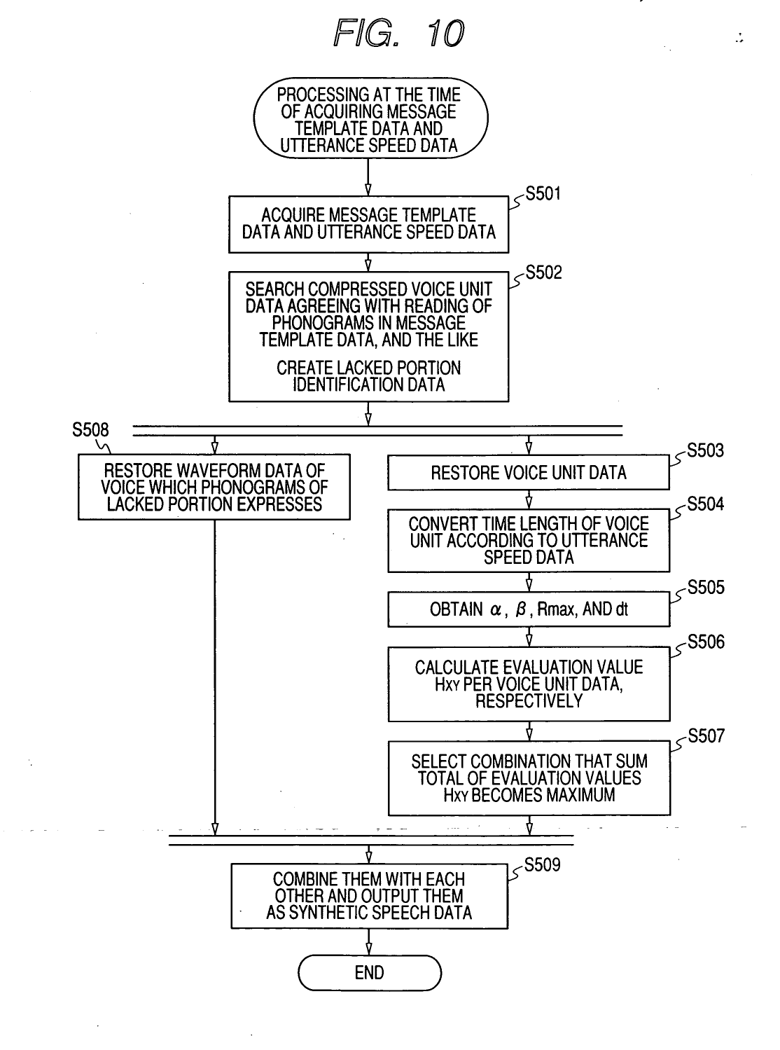

Then, it is assumed that a personal computer which executes these programs to function as the body unit M and voice unit registration unit R in the third embodiment performs the processing shown in FIGS. 6 and 7 as the processing corresponding to the operation of the speech synthesis system in FIG. 1, and further performs the processing shown in FIG. 10.

FIG. 10 is a flowchart showing the processing in the case that this personal computer acquires template message data and utterance speed data.

That is, when acquiring the above-described message template data and utterance speed data from the outside by an arbitrary method (step S501 in FIG. 10), similarly to the above-mentioned processing at step S302, this personal computer first retrieves all the compressed voice unit data with which the phonogram which agrees with the phonogram expresses the reading of a voice unit included in the message template which this message template data expresses is associated, the above-described voice unit reading data, speed initial value data, and pitch component data which are associated with applicable compressed voice unit data (step S502). In addition, also at step S502, when a plurality of compressed voice unit data is applicable to one voice unit, all applicable compressed voice unit data are retrieved, and on the other hand, when there exists a voice unit for which compressed voice unit data is not retrieved, the above-described lacked portion identification data is generated.

Next, this personal computer restores the retrieved compressed voice unit data to voice unit data before being compressed (step S503), and converts the restored voice unit data by the same processing as the processing which the above-described voice unit editor 8 performs to make the time length of the voice unit, which the voice unit data concerned expresses, agree with the speed which the utterance speed data shows (step S504). In addition, when utterance speed data is not supplied, it is not necessary to convert the restored voice unit data.

Next, this personal computer selects optimal combination of voice unit data for synthesizing voice of reading out a message template from among the voice unit data, where the time length of a voice unit is converted, by performing the same processing as the processing which the above-described voice unit editor 8 in the third embodiment performs (steps S505 to S507).

Thus, first, this personal computer calculates a set of the above-described values α and β, and/or Rmax about each pitch component data retrieved at step S502, and calculates the above-described value dt using this speed initial value data, and message template data and utterance speed data which are obtained at step S501 (step S505).

Next, this personal computer specifies the above-mentioned evaluation value H_{XY} on the basis of the value of α, β, Rmax, and dt which are calculated at step S505 about each voice unit data converted at step S504, and a frequency of a pitch component of voice unit data which expresses an adjacent voice unit after a voice unit which the voice unit data concerned expresses within a message template (step S506).

Then, this personal computer selects the combination, where the sum total of evaluation values H_{XY} of respective voice unit data belonging to combination becomes maximum, as the optimal combination of voice unit data for synthesizing the voice which reads out a message template among respective combinations obtained by selecting one piece of voice unit data per one voice unit which constitutes a message template which the message template data obtained at step S501 expresses from among respective voice unit data converted at step S504 (step S507). Nevertheless, it is assumed that, as the evaluation value H_{XY} used for calculating sum total, what reflected the connecting relation of voice units within the combination correctly is selected.

On the other hand, when lacked portion identification data is generated, this personal computer extracts a phonogram string, which expresses the reading of a voice unit which the lacked portion identification data shows, from message template data, restores waveform data which expresses a waveform of voice which each phonogram within this phonogram string shows by performing the processing at the above-described steps S202 to S203 with treating this phonogram string every phoneme similarly to the phonogram string which delivery character string data expresses (step S508).

Then, this personal computer combines the restored waveform data and voice unit data, belonging to the combination selected at step S507, with each other in the order according to the alignment of each voice unit within the message template which message template data shows to output them as data which expresses synthetic speech (step S509).

In addition, a program which makes a personal computer function as the body unit M and voice unit registration unit R may be uploaded, for example, to a bulletin board (BBS) of a communication line to be distributed through the communication line, or, by modulating a carrier wave with a signal which expresses these programs, transmitting the obtained modulated wave, and demodulating the modulated wave by a device which receives this modulated wave, these programs may be restored.

Then, it is possible to execute the above-described processing by starting these programs and executing them similarly to other application programs under the control of OS.

In addition, when OS shares a part of processing, or OS may constitute a part of one component of the claimed invention, programs except the portion may be stored in a recording medium. Also in this case, it is assumed that the program for executing respective functions or steps which a computer executes is stored in that recording medium in this invention.

### INDUSTRIAL APPLICABILITY

According to the present invention, it is possible to achieve a voice selector, a voice selection method, and a program for obtaining natural synthetic speech at high speed in simple configuration.

1. A voice data selector, comprising:
memory means for storing a plurality of voice data expressing voice waveforms;
search means for inputting text information expressing a text and retrieving voice data expressing a waveform of a voice unit whose reading is common to that of a voice unit which constitutes the text from among the voice data; and
selection means for selecting each one of voice data corresponding to each voice unit which constitutes the text from among the searched voice data so that a value obtained by totaling difference of pitches in boundaries of adjacent voice units in the whole text may become minimum.

2. The voice data selector according to claim 1, further comprising:
speech synthesis means of generating data expressing synthetic speech by combining selected voice data mutually.

3. A voice data selection method, the method comprising the steps of:
storing a plurality of voice data expressing voice waveforms;
inputting text information expressing a text, retrieving voice data expressing a waveform of a voice unit whose reading is common to that of a voice unit which constitutes the text from among the voice data; and
selecting each one of voice data corresponding to each voice unit which constitutes the text from among the retrieved voice data so that a value obtained by totaling difference of pitches in boundaries of adjacent voice units in the whole text may become minimum.

4. A program for causing a computer to function as:
memory means for storing a plurality of voice data expressing voice waveforms;
search means for inputting text information expressing a text and retrieving voice data expressing a waveform of a voice unit whose reading is common to that of a voice unit which constitutes the text from among the voice data; and
selection means for selecting each one of voice data corresponding to each voice unit which constitutes the text from among the searched voice data so that a value obtained by totaling difference of pitches in boundaries of adjacent voice units in the whole text may become minimum.

5. A voice selector, comprising:
memory means for storing a plurality of voice data expressing voice waveforms;
prediction means for predicting time series change of pitch of a voice unit by inputting text information expressing a text and performing cadence prediction for a voice unit which constitutes the text concerned; and
selection means for selecting from among the voice data the voice data which expresses a waveform of a voice unit whose reading is common to that of a voice unit which constitutes the text, and whose time series change of pitch has the highest correlation with prediction results by the prediction means.

6. The voice selector according to claim 5, wherein the selection means may specify strength of correlation between time series change of pitch of voice data, and results of prediction by the prediction means on the basis of results of regression calculation which performs primary regression between time series change of pitch of a voice unit which voice data expresses, and time series change of pitch of a voice unit in the text whose reading is common to the voice unit concerned.

7. The voice selector according to claim 5, wherein the selection means may specify strength of correlation between time series change of pitch of voice data, and results of prediction by the prediction means on the basis of a correlation coefficient between time series change of pitch of a voice unit which voice data expresses, and time series change of pitch of a voice unit in the text whose reading is common to the voice unit concerned.

8. A voice selector, comprising:
memory means for storing a plurality of voice data expressing voice waveforms;
prediction means for predicting time length voice unit and time series change of pitch of the voice unit concerned by inputting text information expressing a text and performing cadence prediction for the voice unit in the text concerned; and
selection means for specifying an evaluation value of each voice data expressing a waveform of a voice unit whose reading is common to a voice unit in the text and selecting voice data whose evaluation value expresses the highest evaluation, and in that the evaluation value is obtained from a function of a numerical value which expresses correlation between time series change of pitch of a voice unit which voice data expresses, and prediction results of time series change of pitch of a voice unit in the text whose reading is common to the voice unit concerned, and a function of difference between prediction results of time length of a voice unit which the voice data concerned expresses, and time length of a voice unit in the text whose reading is common to the voice unit concerned.

9. The voice selector according to claim 8, wherein the numerical value expressing correlation comprises a gradient of a primary function obtained by the primary regression between time series change of pitch of a voice unit which voice data expresses, and time series change of pitch of a voice unit in the text whose reading is common to that of the voice unit concerned.

10. The voice selector according to claim 8, wherein the numerical value expressing correlation comprises an intercept of a primary function obtained by the primary regression between time series change of pitch of a voice unit which voice data expresses, and time series change of pitch of a voice unit in the text whose reading is common to that of the voice unit concerned.

11. The voice selector according to claim 8, wherein the numerical value expressing correlation comprises a correlation coefficient between time series change of pitch of a voice unit which voice data expresses, and prediction results of time series change of pitch of a voice unit in the text whose reading is common to that of the voice unit concerned.

12. The voice selector according to claim 8, wherein the numerical value expressing correlation comprises the maximum value of correlation coefficients between a function which what is given various bit count cyclic shifts to data expressing time series change of pitch of a voice unit which voice data expresses, and a function expressing prediction results of time series change of pitch of a voice unit in the text whose reading is common to that of the voice unit concerned.

13. The voice selector according to any one of claims 5 to 12, wherein the memory means stores phonetic data expressing reading of voice data with associating it with the voice data concerned; and
wherein the selection means treats voice data, with which phonetic data expressing the reading agreeing with the reading of a voice unit in the text is associated, as voice data expressing a waveform of a voice unit whose reading is common to the voice unit concerned.

14. The voice selector according to any one of claims 5 to 12, further comprising:
speech synthesis means of generating data expressing synthetic speech by combining selected voice data mutually.

15. The voice selector according to claim 14, comprising:
lacked portion synthesis means of synthesizing voice data expressing a waveform of a voice unit in regard to the voice unit, on which the selection means was not able to select voice data, among voice units in the text without using voice data which the memory means stores, and in that the speech synthesis means generates data expressing synthetic speech by combining voice data, which the selection means selected, with voice data which the lacked portion synthesis means synthesizes.

16. A voice selection method, the method comprising the steps of:
storing a plurality of voice data expressing voice waveforms;
predicting time series change of pitch of a voice unit by inputting text information expressing a text and performing cadence prediction for a voice unit which constitutes the text concerned; and
selecting from among the voice data the voice data which expresses a waveform of a voice unit whose reading is common to that of a voice unit which constitutes the text, and whose time series change of pitch has the highest correlation with prediction results by the prediction means.

17. A voice selection method, the method comprising the steps of:
storing a plurality of voice data expressing voice waveforms;
predicting time length of voice unit and time series change of pitch of the voice unit concerned by inputting text information expressing a text and performing cadence prediction for a voice unit in the text concerned; and
specifying an evaluation value of each voice data expressing a waveform of a voice unit whose reading is common to a voice unit in the text and selecting voice data whose evaluation value expresses the highest evaluation, and in that the evaluation value is obtained from a function of a numerical value which expresses correlation between time series change of pitch of a voice unit which voice data expresses, and prediction results of time series change of pitch of a voice unit in the text whose reading is common to the voice unit concerned, and a function of difference between prediction results of time length of a voice unit which the voice data concerned expresses, and time length of a voice unit in the text whose reading is common to the voice unit concerned.

18. A program for causing a computer to function as:
memory means for storing a plurality of voice data expressing voice waveforms;
prediction means for predicting time series change of pitch of a voice unit by inputting text information expressing a text and performing cadence prediction for a voice unit which constitutes the text concerned; and
selection means for selecting from among the voice data voice data which expresses a waveform of a voice unit whose reading is common to that of a voice unit which constitutes the text, and whose time series change of pitch has the highest correlation with prediction results by the prediction means.

19. A program for causing a computer to function as:
memory means for storing a plurality of voice data expressing voice waveforms;
prediction means for predicting time length of a voice unit and time series change of pitch of the voice unit concerned by inputting text information expressing a text and performing cadence prediction for a voice unit in the text concerned; and
selection means for specifying an evaluation value of each voice data expressing a waveform of a voice unit whose reading is common to a voice unit in the text and selecting voice data whose evaluation value expresses the highest evaluation, and in that the evaluation value is obtained from a function of a numerical value which expresses correlation between time series change of pitch of a voice unit which voice data expresses, and prediction results of time series change of pitch of a voice unit in the text whose reading is common to the voice unit concerned, and a function of difference between prediction results of time length of a voice unit which the voice data concerned expresses, and time length of a voice unit in the text whose reading is common to the voice unit concerned.

20. A voice data selector, comprising:
memory means for storing a plurality of voice data expressing voice waveforms;
text information input means of inputting text information expressing a text;
a search section for searching voice data which has a portion whose reading is common to that of a voice unit in a text which the text information expresses; and
selection means for obtaining an evaluation value according to predetermined evaluation criteria on the basis of relationship between mutually adjacent voice data when each of the searched voice data is connected according to the text which text information expresses, and selecting combination of voice data, which is outputted, on the basis of the evaluation value concerned.

21. The voice data selector according to claim 20, wherein the evaluation criterion is a criterion which determines an evaluation value which shows relationship between mutually adjacent voice data; and
wherein the evaluation value is obtained on the basis of an evaluation expression which contains at least any one of a parameter which shows a feature of voice which the voice data expresses, a parameter which shows a feature of voice obtained by mutually combining voice which the voice data expresses, and a parameter which shows a feature relating to speech time length.

22. The voice data selector according to claim 20, wherein the evaluation criterion is a criterion which determines an evaluation value which shows relationship between mutually adjacent voice data; and that the evaluation value includes a parameter which shows a feature of voice obtained by mutually combining voice which the voice data expresses, and is obtained on the basis of an evaluation expression which contains at least any one of a parameter which shows a feature of voice which the voice data expresses, and a parameter which shows a feature relating to speech time length.

23. The voice data selector according to claim 21 or 22, wherein the parameter which shows a feature of voice obtained by mutually combining voice which the voice data expresses is obtained on the basis of difference between pitches in a boundary of mutually adjacent voice data in the case of selecting at a time one voice data corresponding to each voice unit which constitutes the text from among voice data which expressing waveforms of voice having a portion whose reading is common to that of a voice unit in a text which the text information expresses.

24. The voice data selector according to any one of claims 20 to 22, wherein the evaluation criterion further includes a reference which determines an evaluation value which expresses correlation or difference between voice, which voice data expresses, and cadence prediction results of the cadence prediction means; and that the evaluation value is obtained on the basis of a function of a numerical value which expresses correlation between time series change of pitch of a voice unit which voice data expresses, and prediction results of time series change of pitch of a voice unit in the text whose reading is common to the voice unit concerned, and/or a function of difference between prediction results of time length of a voice unit which the voice data concerned expresses, and time length of a voice unit in the text whose reading is common to the voice unit concerned.

25. The voice data selector according to claim 24, wherein the numerical value expressing correlation comprises a gradient and/or an intercept of a primary function obtained by the primary regression between time series change of pitch of a voice unit which voice data expresses, and time series change of pitch of a voice unit in the text whose reading is common to that of the voice unit concerned.

26. The voice data selector according to claim 25, wherein the numerical value expressing correlation comprises a correlation coefficient between time series change of pitch of a voice unit which voice data expresses, and prediction results of time series change of pitch of a voice unit in the text whose reading is common to that of the voice unit concerned.

27. The voice data selector according to claim 25, wherein the numerical value expressing correlation comprises the maximum value of correlation coefficients between a function which what is given various bit count cyclic, shifts to data expressing time series change of pitch of a voice unit which voice data expresses, and a function expressing prediction results of time series change of pitch of a voice unit in the text whose reading is common to that of the voice unit concerned.

28. The voice selector according to any one of claims 20 to 22, wherein the memory means stores phonetic data expressing reading of voice data with associating it with the voice data concerned; and
wherein the selection means treats voice data, with which phonetic data expressing reading agreeing with reading of a voice unit in the text is associated, as voice data expressing a waveform of a voice unit whose reading is common to the voice unit concerned.

29. The voice selector according to any one of claims 20 to 22, wherein speech synthesis means of generating data expressing synthetic speech by combining selected voice data mutually.

30. The voice data selector according to claim 29, comprising:
lacked portion synthesis means for synthesizing voice data expressing a waveform of a voice unit in regard to a voice unit, on which the selection means is not able to select voice data, among voice units in the text without using voice data which the memory means stores, and in that the speech synthesis means generates data expressing synthetic speech by combining a voice data, which the selection means selects, with voice data which the lacked portion synthesis means synthesizes.

31. A voice data selection method, the method comprising the steps of:
storing a plurality of voice data expressing voice waveforms;
inputting text information expressing a text;
searching voice data which has a portion whose reading is common to that of a voice unit in a text which the text information expresses;
obtaining an evaluation value according to predetermined evaluation criteria on the basis of relationship between mutually adjacent voice data when each of the searched-voice data is connected according to a text which text information expresses; and
selecting combination of voice data, which is outputted, on the basis of the evaluation value concerned.

32. A program for causing a computer to function as:
memory means for storing a plurality of voice data expressing voice waveforms;
text information input means for inputting text information expressing a text;
a search section for searching voice data which has a portion whose reading is common to that of a voice unit in a text which the text information expresses; and
selection means for obtaining an evaluation value according to a predetermined evaluation criterion on the basis of relationship between mutually adjacent voice data when each of the searched voice data is connected according to a text which text information expresses, and selecting combination of voice data, which is outputted, on the basis of the evaluation value concerned.
